(19) United States
(12) Patent Application Publication
(10) Pub. No.: US 2012/0101929 A1
(43) Pub. Date: Apr. 26, 2012

(54) PARALLEL PROCESSING DEVELOPMENT ENVIRONMENT AND ASSOCIATED METHODS

(75) Inventor: Kevin D. Howard, Tempe, AZ (US)

(73) Assignee: MASSIVELY PARALLEL TECHNOLOGIES, INC., Boulder, CO (US)

(21) Appl. No.: 13/219,363

(22) Filed: Aug. 26, 2011

Related U.S. Application Data
(60) Provisional application No. 61/377,422, filed on Aug. 26, 2010.

(51) Int. Cl. G06Q 20/38; G06F 9/44; G06Q 10/06

(52) U.S. Cl. 705/35; 705/321; 717/127; 717/120

(57) ABSTRACT

A parallel processing development environment has a graphical process control server that provides an interface through which a developer may access the environment to create a parallel processing routine. The development environment also includes a financial server for managing license and usage fees for the parallel processing routine, wherein the developer of the parallel processing routine receives a portion of the license and usage fees received for the routine. The environment identifies plagiarism and malicious software within the parallel processing routine.

### RELATED APPLICATIONS

This application claims the benefit of U.S. Provisional Application Ser. No. 61/377,422 filed Aug. 26, 2010, which is incorporated herein by reference.

### BACKGROUND

Conventional parallel processing software development models either (a) create no revenue for the developers (Open source, GPL model), (b) pay the developers by sharing in a corporate environment (profit sharing at the discretion of a company or controlling organization), (c) pay the developers per programming job (consulting), or (d) pay the developers per time period (salary model). These payment models are at the discretion of some controlling company. Thus, developers may not fully reap the rewards of their labors.

The controlling company itself typically receives remuneration only for completed applications. The exception is if the company creates libraries of specialized functions and sells entire libraries. Writing software is very time consuming, with developers needing to redevelop various software code components over and over again, even though the same or other organizations may have already developed the required functionality. This is because there is no current method of identifying and accessing those previously created software components. What is missing is a business model that allows developers from multiple, non-associated organizations to share useful software functionality such that 1) the required software functionality can be quickly identified, 2) such codes can be easily accessed, 3) the underlying software codes are inherently protected from theft, and 4) the originating company can receive remuneration from the use of their functionality.

Presently, an individual or organization can purchase a single copy of an application which places a copy of the underlying code on the purchaser's equipment. This can allow the purchaser to duplicate the underlying code, repackage the duplicated code, and resell the duplicated code with no recompense to the original development organization. During application development, it can be very difficult for the development organization to know if it has a performance advantage over its competitors. Similarly, application program purchasers must depend primarily upon the claims of the application creating organizations, with little head-to-head comparison capability available. Since the performance of an application can be a function of the specific data processed by that application, the ability to compare the performance of multiple applications under the user's conditions can be extremely valuable to the application purchaser, and is not directly available through third-party evaluations.

### BRIEF DESCRIPTION OF THE DRAWINGS

FIG. 1 shows one exemplary parallel processing development environment that allows one or more developers to create and manage parallel processing routines that run on a cluster of processing nodes, in one embodiment.

FIG. 2 shows one exemplary algorithm, created by a developer, that includes three kernels and another algorithm, in one embodiment.

FIG. 3 shows one exemplary scenario where a user accesses program the management server of FIG. 1 to perform a task by selecting a program to process data using the cluster of FIG. 1.

FIG. 4 shows exemplary use of the development server of FIG. 1 for comparing performance of a first routine processing test data to the performance of a second routine processing the test data.

FIG. 5 shows one exemplary method for automatically determining the Amdahl Scaling of a parallel processing routine, in one embodiment.

FIG. 6 is a flowchart illustrating one exemplary method for automatically evaluating a first parallel processing routine against one or more other parallel processing routines stored within the environment of FIG. 1.

FIGS. 7A and 7B show exemplary first software source code submitted to the environment of FIG. 1 by a first developer.

FIGS. 8A and 8B show exemplary second software source code submitted to the environment of FIG. 1 by a second developer.

FIG. 9 shows one exemplary method for determining a percentage of plagiarism in software source code, in one embodiment.

FIG. 10 shows one exemplary redaction process for redaction of software source code into redacted functional components.

FIGS. 11, 12 13 and 14 show an exemplary function table variable tables functions of the software source code of FIGS. 8A and 8B.

FIG. 15 shows one exemplary source compare file generated from the source code of FIGS. 8A and 8B by removing formatting, comments, variable names, and file names.

FIG. 16 shows one exemplary source compare file generated by ordering, in ascending size, of functions within the source compare file of FIG. 15.

FIGS. 17, 18, and 19 show exemplary component redaction files for first function ‘power’, second function ‘power1’, and third function ‘main,’ respectively, generated from the software source code of FIGS. 8A and 8B.

FIGS. 20, 21, 22, and 23 show one exemplary second function table, and three second variable tables, respectively, generated from the software source code of FIGS. 7A and 7B.

FIG. 24 shows one exemplary source compare file generated from the software source code of FIGS. 7A and 7B by removing formatting, comments, variable names, and file names.

FIG. 25 shows one exemplary source compare file generated by ordering, in ascending size, functions within the source compare file of FIG. 24.

FIGS. 26, 27 and 28 show exemplary source compare files for functions ‘power’, ‘power1, and ‘main’, respectively, generated from the software source code of FIGS. 7A and 7B.

FIG. 29 shows exemplary data files generated from a software source code file.

FIG. 30 shows a snippet of exemplary software source code illustrating code blocks, independent statements, and dependent statements.

FIG. 31A shows one exemplary table illustrating matching between the first 19 characters of each of the source compare files if FIGS. 16 and 25.

FIG. 31B shows an exemplary table resulting from the application of the Needleman-Wunsch equation to the table of FIG. 31A.

FIG. 31C shows an exemplary Smith-Waterman dot table illustrating provisions for gap detection.

FIG. 31D-F show exemplary scenarios illustrating a plagiarism percentage match between version X and existing software source code.

FIG. 32 shows exemplary files used when detecting malicious software behavior within software source code, in one embodiment.

FIG. 33 shows exemplary software source code submitted to the environment of FIG. 1 by a developer.

FIG. 34 shows one exemplary process for amending the software source code of FIG. 33 to form augmented source code.

FIG. 35 shows one exemplary code insert for creating and opening a tracking file.

FIG. 36 shows one exemplary code insert that calls a function to append a current date and time and segment number to the tracking file.

FIG. 37 shows one exemplary code insert for closing the tracking file.

FIGS. 38A and 38B show exemplary code inserts within the software source code of FIG. 33.

FIG. 39 shows exemplary comment inserts within the software source code of FIG. 33.

FIGS. 40A and 40B show exemplary placement of variable address detection code within the augmented source code of FIG. 32 to determine the starting address of variables at run time.

FIG. 41 shows one exemplary variable tracking table for storing variable information.

FIG. 42 shows one exemplary table illustrating output of a current address detector function.

FIG. 43 shows one exemplary allocated resources table.

FIGS. 44A and 44B show exemplary augmentation to the augmented source code of FIG. 32.

FIGS. 45A and 45B show the augmented source code of FIG. 32 with conditional branch forcing.

FIG. 46 shows one exemplary function-structure diagram.

FIGS. 47A and 47B show exemplary amendments to the augmented source code of FIG. 32 to include code tags and code to evaluate the returned previously executed segment number and conditionally execute a “goto” command.

FIG. 48 shows one exemplary algorithm trace display that shows kernels and an algorithm.

FIG. 49 shows the environment of FIG. 1 with an ancillary resource server that provides ancillary services to developers, administrators and organizations that utilize the environment.

FIG. 50 is a flowchart showing an exemplary method for generating permutated multiple instances of code found in a software code statement.

### DETAILED DESCRIPTION

An organization that utilizes the parallel processing development environment may include one or more administrators and zero or more developers. The organization may represent an actual company with employees that utilize the parallel processing development environment, or may represent a collective of individuals that cooperate to develop parallel processing routines using the parallel processing development environment.

The parallel processing development environment represents a client/server-based, multicore, multiserver, graphical process-control, computer program management, and application-construction collaboration system.

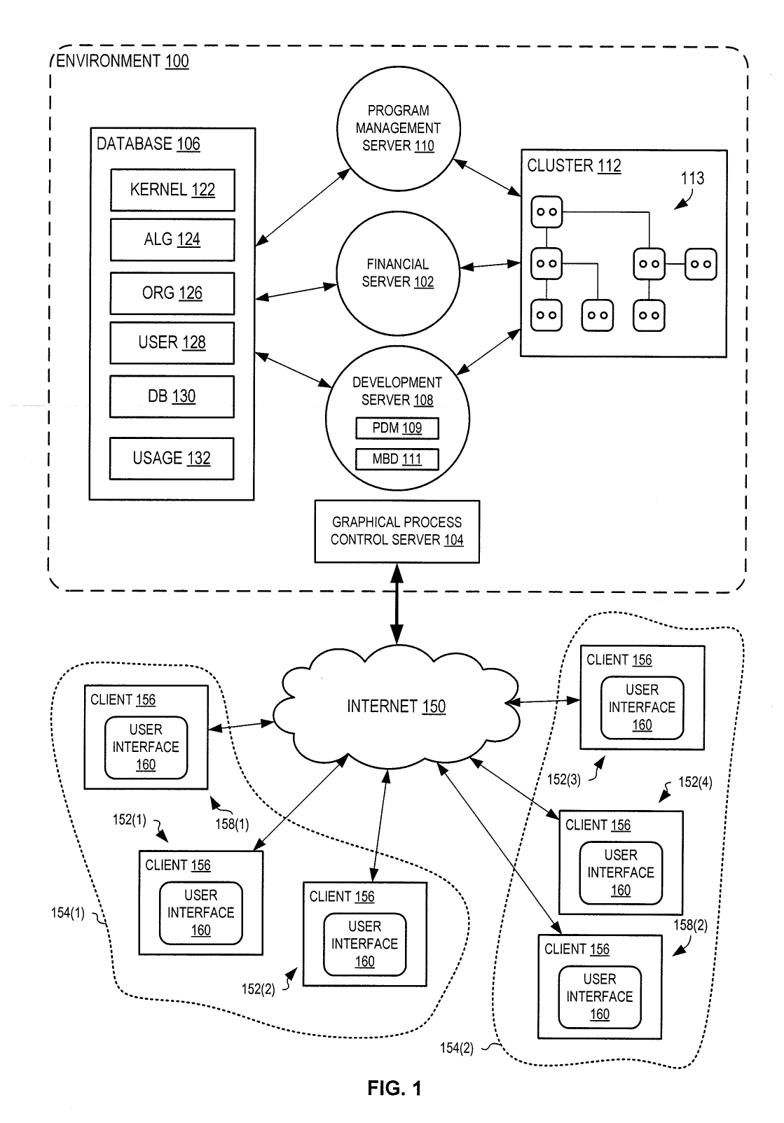

FIG. 1 shows one exemplary parallel processing computing development environment 100 that allows one or more developers to create and manage parallel processing routines that run on a cluster 112 of processing nodes 113. A parallel processing routine is comprised of one or both of (a) one or more kernels and (b) one or more algorithms. As used herein, a “kernel” is a software module that performs a particular function to process data when executed by one or more processing nodes 113 of cluster 112.

Environment 100 includes a graphical process control server 104 that provides an interface to the Internet 150, through which one or more developers 152 may access environment 100 concurrently. Environment 100 also includes one or more database for storing kernel 122, algorithm 124, organization 126, user 128, database 130, and usage information 132. A development server 108 of environment 100 facilitates creation and maintenance of kernels 122 and algorithms 124 in cooperation with graphical process control server 104 and database 106. A program management server 110 of environment 100 facilitates access to a cluster 112 of environment 100 to execute one or more algorithms 124 and kernels 122.

As illustrated in FIG. 1, developers 152 may be grouped into organizations 154 such that kernels 122 and algorithms 124 created by these developers are organized and accessed based upon controls configured for each organization 154. Each organization 154 may also include one or more administrators 158 that control access to, and cost of, each created kernel and algorithm within their organization 154. For example, each kernel created by developer 152(1) is tested and approved by administrator 158(1), and then published for use by developers within other organizations, such as by developers 152(3), 152(4) within organization 154(2). An administrator 158 may define a license fee and a usage cost for each kernel 122 and algorithm 124 created by developers 152 within their organization 154.

As shown in FIG. 1, processing nodes 113 of cluster 112 may be formed into a Howard cascade for processing one or more parallel processing routines in parallel.

Development server 108 allows developer 152, through interaction with graphical process control server 104, to submit a kernel and/or an algorithm for testing within environment 100. Development server 108 stores received kernels and algorithms within database 106 and in association with developer 152 and organization 154. In one embodiment, database 106 represents a relational database and a file store. Additional control information is stored within database 106 (e.g., within separates database tables, not shown) in association with these kernels and algorithms that define access and cost of each kernel and algorithm.

Environment 100 also includes a financial server 102 that provides payment to organizations 154, administrators 158, and developers 152 based upon license fees and usage fees received for each of the organizations kernels and algorithms. For example, kernel 122 developed by developer 152(1) of organization 154(1) may be incorporated into algorithm 124 developed by developer 152(3) of organization 154(2). A license fee, defined by administrator 158(1), for kernel 122 is paid by organization 154(2) and a first part of the license fee is distributed to developer 152(1), a second part of the license fee is distributed to administrator 158(1), and a third part of the license fee is distributed to organization 154(1). A fourth part of the license fee may be accrued by financial server 102 as payment for use of environment 100. That is, environment 100 may not charge connect and use time for each developer and administrator, but instead receives financial compensation based upon a percentage of license fees and usage fees associated with each kernel and algorithm. Similarly, developed algorithms may be sold, through environment 100, to other organizations, and proceeds from the sale may be distributed to the owning organization, its administrators, and its developers, with environment 100 receiving a percentage of the overall sale price.

Each kernel 122 and algorithm 124 within database 106 has a defined category and a set of keywords that classify each kernel and algorithm within environment 100. Categories may include ‘cross-communication’, ‘image-processing’, ‘mmo-gaming-tools’, and so on. Additional keywords may be associated with each kernel and algorithm to define features thereof in detail, such as required parameters and data output formats. Kernels and algorithms stored within database 106 may be selected by developers inputting a category and/or one or more keywords.

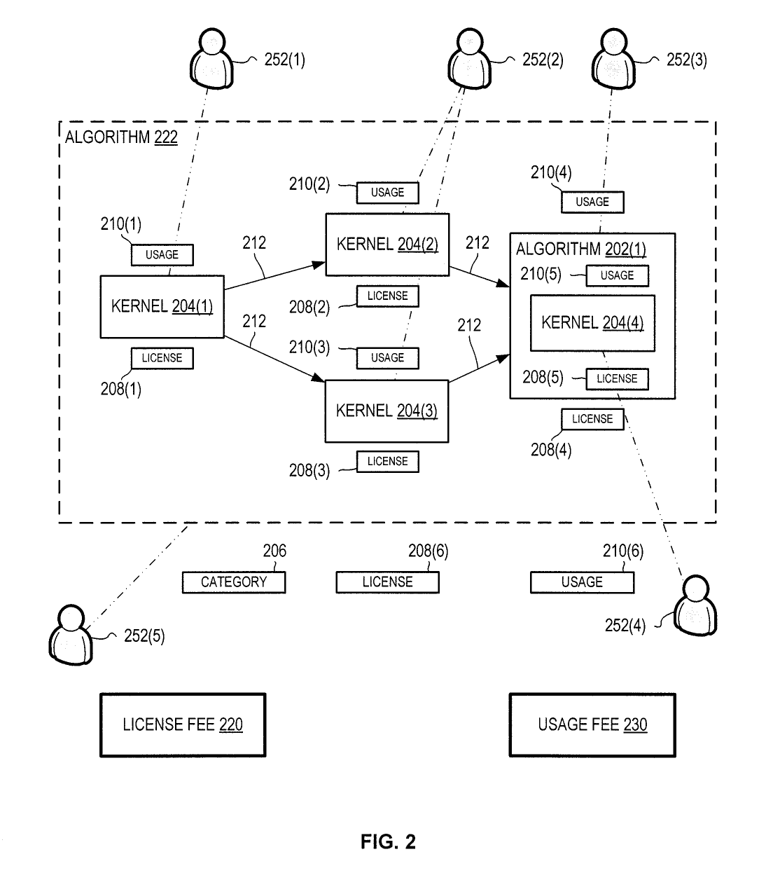

FIG. 2 shows one exemplary algorithm 222 that is created by a developer 252(5) from three kernels 204(1), 204(2) and 204(3) and another algorithm 202(1). Kernel 204(1) was created by developer 252(1), kernels 204(2) and 204(3) were created by a developer 252(2) and algorithm 202(1) was created by a developer 252(3) and includes a kernel 204(4) created by a developer 252(4).

Each kernel (e.g., kernels 204) represents a software routine that runs on cluster 112, FIG. 1, and is developed by one or more developers 152. An algorithm (e.g., algorithm 202(1)) represents one or more kernels and/or other algorithms that are combined to provide a desired function when run on cluster 112. Kernels 204 and algorithms 202 may represent kernel 122 and algorithm 124, FIG. 1, respectively. Each kernel 204 and algorithm 202 has a defined usage cost 210, that is paid each time the kernel/algorithm is used, and a defined license cost 208 that is paid for a defined license period of the kernel/algorithm.

In the example of FIG. 2, algorithm 222 is created by combining kernels 204(1), 204(2), 204(3) and algorithm 202(1). Algorithm 222 may similarly be included within other algorithms when licensed. Arrows 212 represent data flow between kernels 204 and algorithm 202(1). As shown in FIG. 2, algorithm 222 has a defined category 206, a license cost 208, and a usage cost 210. Optionally, keywords may also be associated with algorithm 222 to facilitate selection of algorithm 222 by other developers. Since algorithm 222 includes kernels 204 and algorithm 202(1), license cost 208(6) is equal to, or greater than, the sum of license costs 208(1), 208(2), 208(3), and 208(4). Similarly, usage cost 210(6) is equal to, or greater than, the sum of usage costs 210(1), 210(2), 210(3), and 210(4). Similarly again, usage cost 210(4) is equal to, or greater than, usage cost 210(5) of kernel 204(4), and license cost 208(4) is equal to, or greater than, license cost 208(5) of kernel 204(4).

In one embodiment, environment 100 ensures that, upon creation of a new algorithm, the usage cost and license cost is equal to or greater than the sum of the usage costs and components costs, respectively, of the components included therein. Specifically, when algorithm 222 is licensed (or used), environment 100 ensures that developer(s) 152 of each kernel 204 and algorithm 202 included therein receives an appropriate portion of a license fee 220 and/or a usage fee 230 paid for algorithm 222.

When creating algorithm 222, developer 152 requires a license for each kernel 204 and algorithm 202 used therein. Developer 152 therefore pays a new license of each kernel 204 and/or algorithm 202, unless a license for each of these kernels and algorithm is already held by developer 152. Environment 100 operates to ensure that developer 152 pays any necessary license costs 208 prior to allowing developer 152 to include any selected kernel 204 and/or algorithm 202 within a new algorithm.

Once a new kernel or algorithm is created, it may remain private for use within the creating organization, or it may be published for use by developers within other organizations. In one embodiment, user interface 160, FIG. 1, within each client 156 displays only kernels 204 and algorithms 202 available to the developer 152 logged in at that client. User interface 160 is described in detail within Appendix A.

Environment 100 controls licensing and use of kernels 204 and algorithms 202, 222, tracks their earned usage and license fees, and thereby allows developers to share income from developed routines and algorithms. Further, sharing and re-use of developed software is encouraged and rewarded by environment 100 through automatic control and payment of license fees and usage fees.

To encourage developers to create and publish parallel processing algorithms (e.g., kernels and algorithms), environment 100 does not charge developers for use of the facilities provided by environment 100. Rather, environment 100 retains a percentage of the usage fees and license fees earned by each kernel and algorithm as it is licensed and used. This fee is added on top of the other fees such that the requested income flow remains unimpeded.

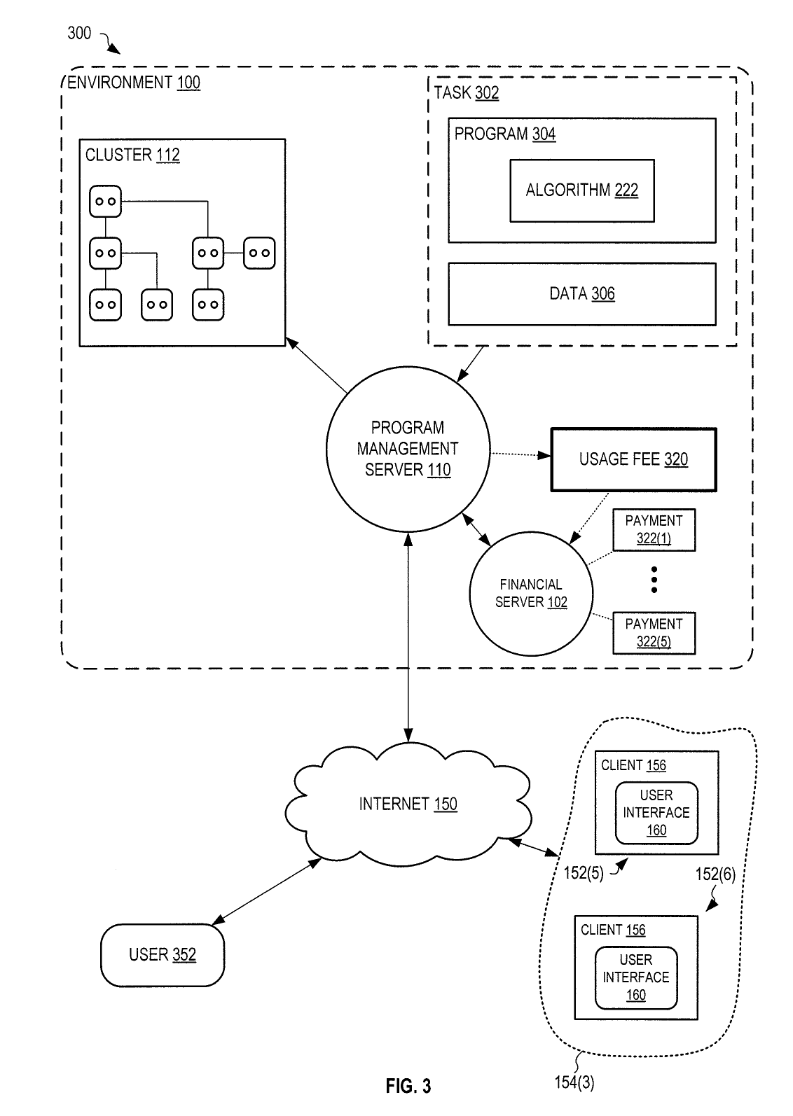

FIG. 3 shows one exemplary scenario 300 where a user 352 accesses program management server 110 of environment 100 to perform a task 302 by selecting a program 304 to process data 306 using cluster 112. Program management server 110 may, for example, provide a graphical interface that interacts with user 352 via Internet 150 to allow selection of program 304 from a plurality of stored (e.g., within database 106) parallel processing routines (e.g., kernels and algorithms) developed for running on cluster 112 by developers 152. Program management server 110 may, for each program stored within database 106, provide detailed cost and functionality information to user 352 such that user 352 may make an educated selection of program 304 based upon data processing requirements together with cost and performance. User 352 may upload data 306 to environment 100 via Internet 150, or use other means for providing data 306 to cluster 112.

Upon running of program 304 on cluster 112 to process data 306, program management server 110 determines an appropriate usage fee 320, payable by user 352 based upon usage costs of program 304, size and type of data 306, and the number of processing nodes 113 of cluster 112 selected for running program 304. Program management server 110 may inform financial server 102 of usage fee 320, such that financial server 102 may determine payments 322, based upon components of program 304, for developers 152. Using the examples of FIGS. 2 and 3, program 304 includes algorithm 222, and therefore developers 152 of kernels 204(1), 204(2), 204(3), and 204(4) and developers of algorithm 202(1), and algorithm 222, each receive an appropriate portion (shown as payments 322(1)-322(5)) of usage fee 320 based upon defined usage costs 210 of each included component. Financial server 102 accrues payments to each developer 152 based upon usage of components in each program (e.g., program 304) run on cluster 112.

Financial server 102 also withholds a certain percentage of usage fee 320 as payment for use of environment 100 by developers 152(1)-(5), since these developers contributed to algorithm 222. User 352 may select higher performance processing for a particular task, and pay a premium price for that higher performance from environment 100. A task selected for higher performance processing may utilize additional processing nodes of cluster 112 or may have a higher priority that ensures nodes are allocated to the task in preference to lower priority task node requests. Payment for this higher performance processing is used only to pay for use of environment 100 and not paid to developers.

Parallel processing routines (e.g., kernels and algorithms) and databases (e.g., database 130, FIG. 1) stored within environment 100 are classified by organization, a category within that organization, and a given name. In one example of operation, developers 152 first select the organization, then the category and then the name of a desired parallel processing routine and/or database from user interface 160. Developers 152 may also define a keyword list within user interface 160 that will limit the number of parallel processing routines and databases displayed within user interface 160 for a particular organization and category.

“Massively Parallel Technologies” is one exemplary organization name, which may be abbreviated to “MPT” on a button or control of user interface 160. Where the organization name is abbreviated within user interface 160, if the developer ‘hovers’ the mouse over the abbreviation, the full organization name will be displayed. Within an organization, exemplary categories are: “cross-communication,” “image-processing,” and “mmo-gaming-tools.” These categories would appear within user interface 160 once the organization is selected. Exemplary parallel processing routine names are: “PAAX-exchange,” “FAAX-exchange,” and “Howard-Cascade.”

In one example of operation, developer 152(5) first selects the name “MPT” of organization 154(3) and then category cross-communication, and then a kernel called Howard-Cascade. Developer 152(5) may then include the selected kernel within a new algorithm or profile the kernel to determine characteristics based upon a test data set.

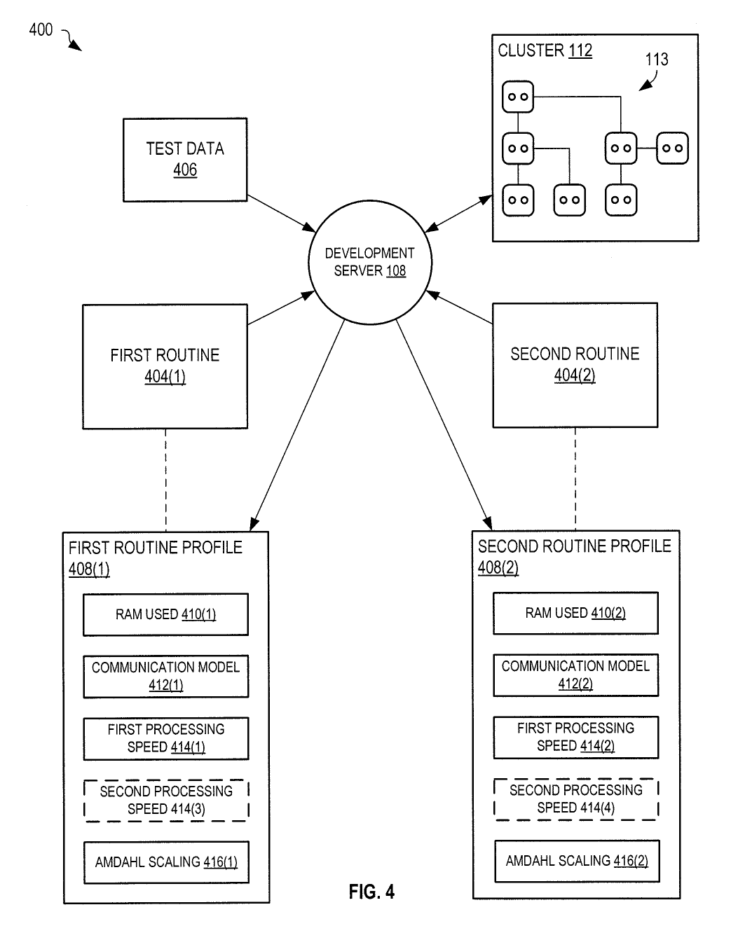

FIG. 4 shows exemplary use of development server 108 for comparing performance of a first routine 404(1) processing test data 406 to the performance of a second routine 404(2) processing test data 406. Test data 406 may exist within environment 100 or may be uploaded by a developer 152. First routine 404(1) and second routine 404(2) may represent instances of kernel 122, 204 and/or algorithms 124, 202, 222 of FIGS. 1 and 2. First routine 404(1) and second routine 404(2) are similar, in that they both perform the same function and have the same input and output parameters, but may include different kernels and/or algorithms. Routines 404 fall within the same category and may have similar keyword descriptors.

Development server 108 profiles each of first routine 404(1) and second routine 404(2) to determine first routine profile 408(1) and second routine profile 408(2), respectively. Each routine profile 408 includes one or more of: amount of RAM used 410, communication model 412, first and second processing speed 414 and Amdahl Scaling 416. In one embodiment, one routine profile 408 is created for each communication model 412 selected for routine 404. Selection of a particular communication model may result from profiling the routine using each available communication model, or may be made by a user.

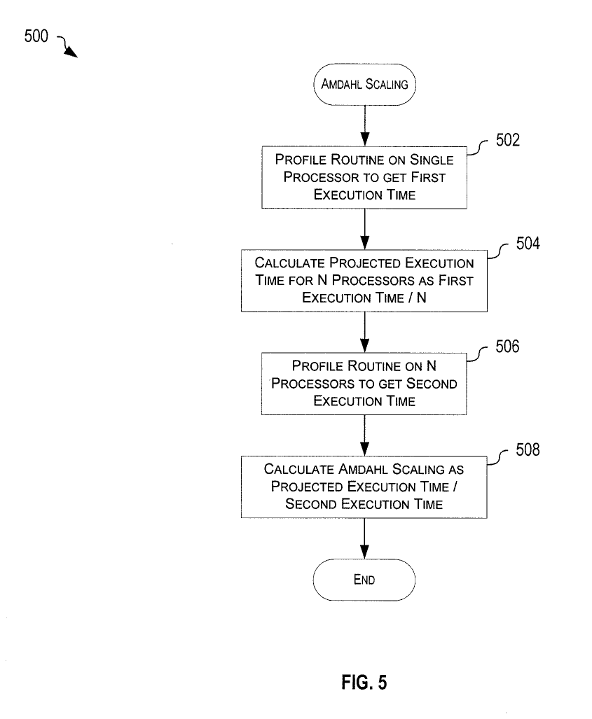

In one example of operation, development server 108 profiles first routine 404(1) running on a single processing node of cluster 112 to process test data 406 and derives RAM used 410(1), communication model 412(1) and a first processing speed 414(1) based upon the execution time of the first routine to process the test data. Development server 108 then profiles first routine 404(1) running on ten processing nodes of cluster 112 to process test data 406 and derives a second processing speed 414(3). Processing speed and execution time are used interchangeably herein to represent the processing performance of the parallel processing routines, and not the computing power of the processing node. For example, first processing speed 414(1) represents the execution time for processing test data 406 by first routine 404(1) on a single processing node of cluster 112. Development server 108 then determines Amdahl Scaling 416(1) based upon the first processing speed 414(1), the determined second processing speed 414(3) and the number of processing nodes (N) used to determine the second processing speed 414(3), as described in association with FIG. 5 below. Development server 108 then repeats this sequence for second routine 404(2) to determine second routine profile 408(2).

To encourage the use of the most appropriate kernels and algorithms, and to allow developers to evaluate newly created kernels and/or algorithms, environment 100 allows a developer or user to compare kernels and algorithms against one another, such that the best kernel/algorithm for a particular task may be identified and incorporated into that task. Many factors determine suitability of a kernel and/or algorithm for a particular task, including, but not limited to, size of the data set, parameters input to the kernel and/or algorithm, number of processing nodes selected for processing the kernel and/or algorithm, and Amdahl Scaling of the kernel and/or algorithm.

In one embodiment, environment 100 does not save routine profiles 408 within database 106, since conditions for evaluating the parallel processing routines typically change, particularly since each developer evaluates the routines utilizing their own test data tailored to their processing specifications and requirements. Environment 100 facilitates automatic evaluation of new and existing the parallel processing routines against test data and input parameters to allow a developer to select optimal kernels and algorithms based upon their data requirements. In another embodiment, environment stores routine profiles 408 in relation to test data 406 and the evaluating developer 152, such that a developer need not profile routines more than once when input parameters and test data have not changed.

FIG. 5 shows one exemplary method 500 for automatically determining the Amdahl Scaling of a parallel processing routine, such as a kernel and an algorithm for example. Amdahl Scaling allows performance of the routine executed on multiple processing nodes to be predicted, such as when executed by a plurality of processing nodes 113 within cluster 112 of FIG. 1. Method 500 is implemented by one or more of development server 108 and processing nodes 113.

In step 502 of method 500, the routine is profiled on a single processing node to get a First Execution Time. In one example of step 502, development server 108 profiles first routine 404(1) processing test data 406 within a single processing node of cluster 112 to determine first processing speed 414(1). In step 504, a projected execution time of the routine on N-processing nodes is calculated as First Execution Time/N, where N is the number of processing nodes used for profiling. In one example of step 504, ten processing nodes 113 are to be used to profile routine 404(1) in step 506, and thus N equals 10, giving the predicted execution time as first processing speed 414(1) divided by 10. In step 506, the routine is profiled on N processing nodes to determine a second execution time. In one example of step 506, development server 108 profiles routine 404(1) processing test data 406 on ten processing nodes 113 of cluster 112 to determine second processing speed 414(3). In step 508, the Amdahl Scaling is calculated as the Projected Execution Time/Second Execution Time. In one example of step 508, the first processing speed 414(1) is divided by ten, since ten processing nodes 113 were used in step 506, and then divides this result by second processing speed 414(3). If the first execution time is 10 seconds, and the second execution time is 5 seconds, the Amdahl Scaling factor is 0.5. An Amdahl Scaling factor of one is ideal; parallel processing routines having an Amdahl Scaling value close to one scale more efficiently than routines with a smaller Amdahl Scaling factor.

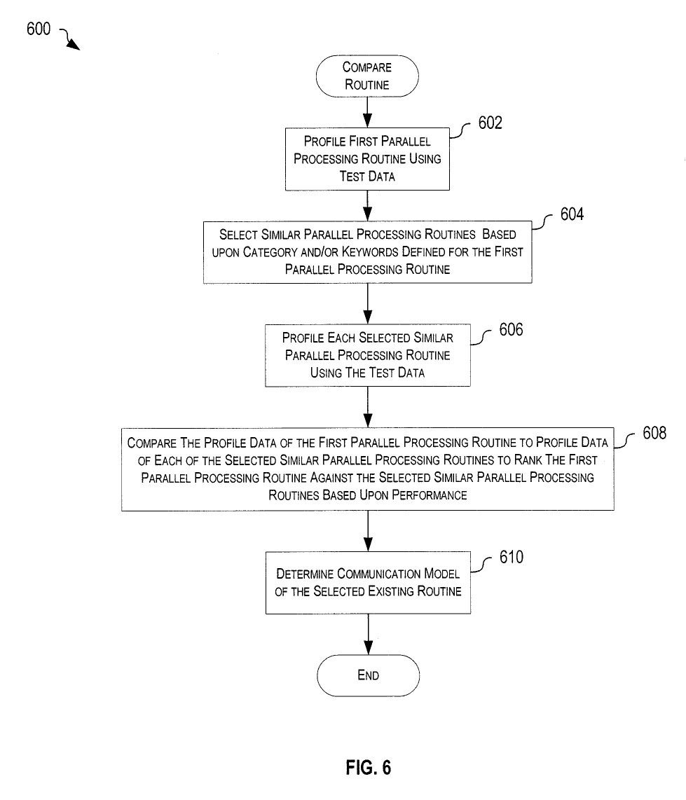

FIG. 6 is a flowchart illustrating one exemplary method 600 for automatically evaluating a first parallel processing routine against one or more other parallel processing routines stored within environment 100. In step 602, a first parallel processing routine is profiled using a set of test data. In one example of step 602, routine 404(1) is created by developer 152(1) and profiled by development server 108 using method 500 of FIG. 5 and test data 406. In step 604, similar parallel processing routines are selected based upon a category and/or keywords defined for the first parallel processing routine. In one example of step 604, development server 108 utilizes the defined category and keywords for routine 404(1) to select other similar kernels and algorithms within database 106.

In step 606, each selected similar parallel processing routine is profiled using the test data. In one example of step 606, development server 108 utilizes method 500 to profile second routine 404(4) processing test data 406 and generates routine profile 408(2). In step 608, the profile data of the first parallel processing routine is compared to profile data of each of the selected similar parallel processing routines to rank the first parallel processing routine against the selected similar parallel processing routines. In one example of step 608, where efficiency of parallel scaling is of greatest importance, development server 108 compares first routine profile 408(1) against second routine profile 408(2) and ranks first routine 404(1) against second routine 404(2) based upon Amdahl Scaling 416 within each routine profile 408. In step 610, the communication model of the selected existing routine is then determined.

Optionally, developer 152 may prioritize elements of routine profile 408 to influence the ranking of step 608. For example, for a particular application where the maximum amount of RAM used is based upon the size of the data being processed, the algorithm that utilizes less RAM may be more valuable than the algorithm with the fastest processing speed. Thus, developer 152 may define RAM used 410 as the highest priority element within routine profiles 408, such that development server 108, in step 608 of method 600, ranks the kernel with the lowest RAM used 410 value above other profiled characteristics.

In one example of operation, developer 152 uses environment 100 to evaluate a new kernel against existing kernels with similar functionality within environment 100 using test data 406. Development server 108 selects kernels from database 106 based upon one or both of category and defined keywords defined by developer 152 for the new kernel. Development server 108 profiles, using method 600 of FIG. 6, the new kernel, and each of these selected kernels using test data 406. Development server 108 then and presents determined routine profiles (e.g., routine profiles 408) to developer 152. Where developer 152 has created an improved kernel that utilizes a more efficient internal algorithm to perform a similar function as the selected kernels, developer 152 may compare the performance of the new kernel against existing kernels and thereby evaluate the new kernel.

Software Plagiarism Detection

Unscrupulous software developers may copy (or use a close imitation of) computer code and ideas developed by another developer, and present this replicated code as original work. Software is easily duplicated, and, thus, its value can be easily harmed. Source code is easily modified, without changing its functionality, using global find-and-replace methods and/or by rearranging the order of the functions within the source code. By combining these two modifications, it is difficult for the uninitiated to recognize software plagiarism.

In the following example, the ‘C’ software language is used, however, other software languages may be used in place of the ‘C’ software language without departing from the scope hereof. Further, the amount of formatting that is ignored by a compiler of software source code varies between software languages, and only formatting that has no effect on the compiled code is removed in the following methodology.

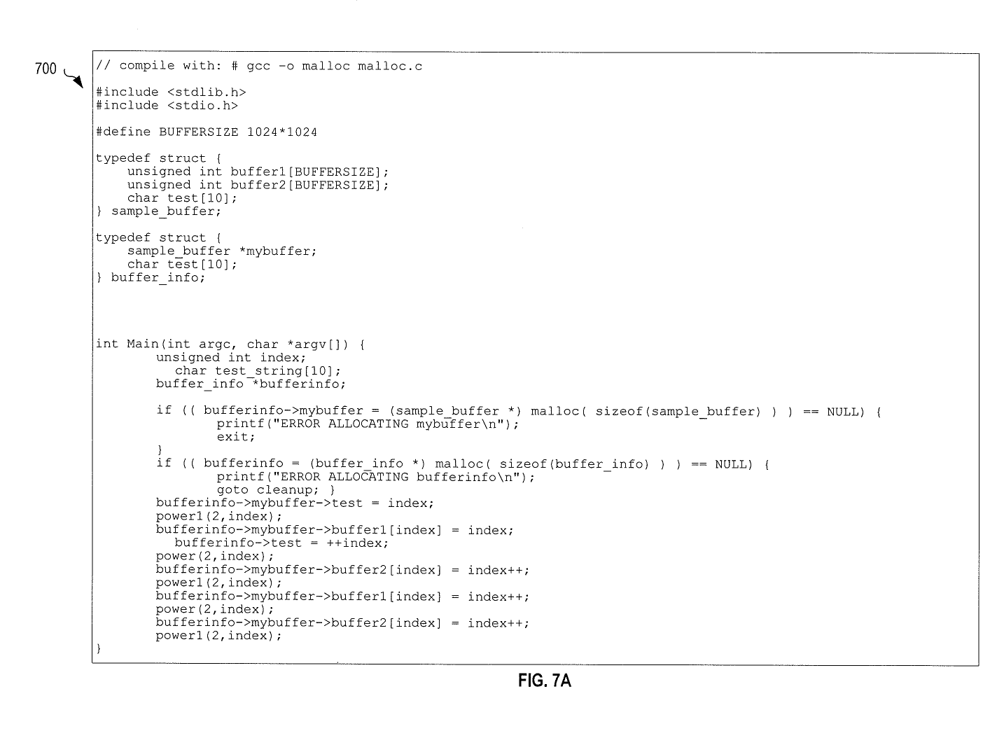

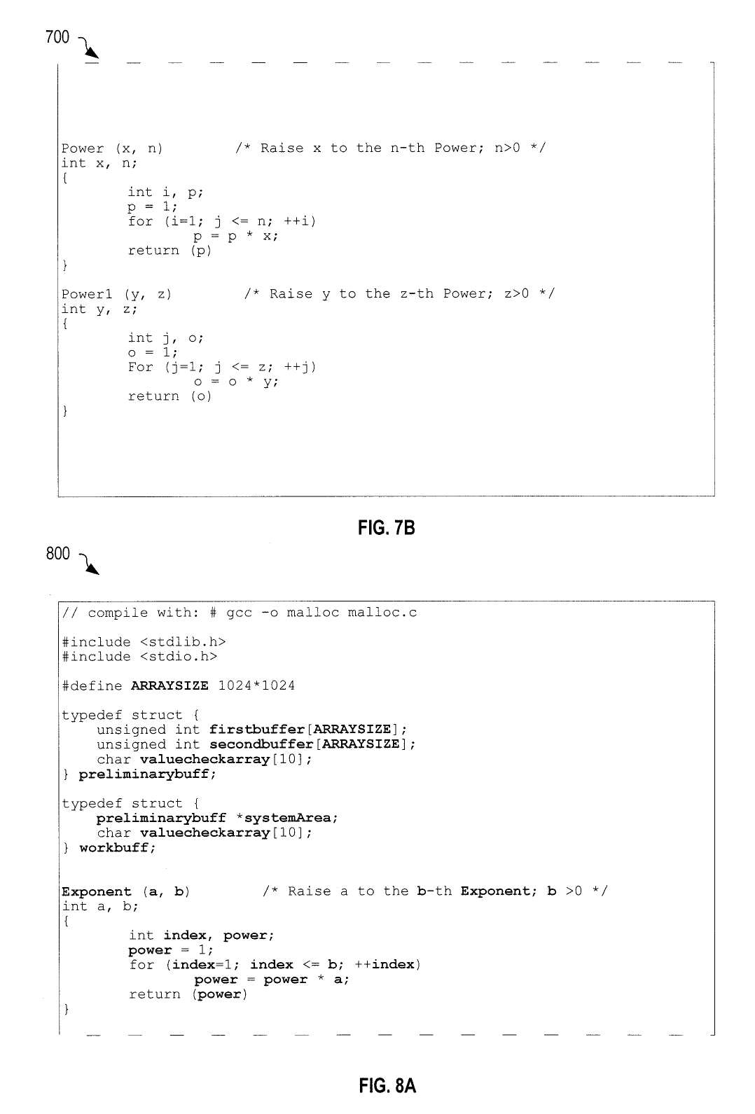

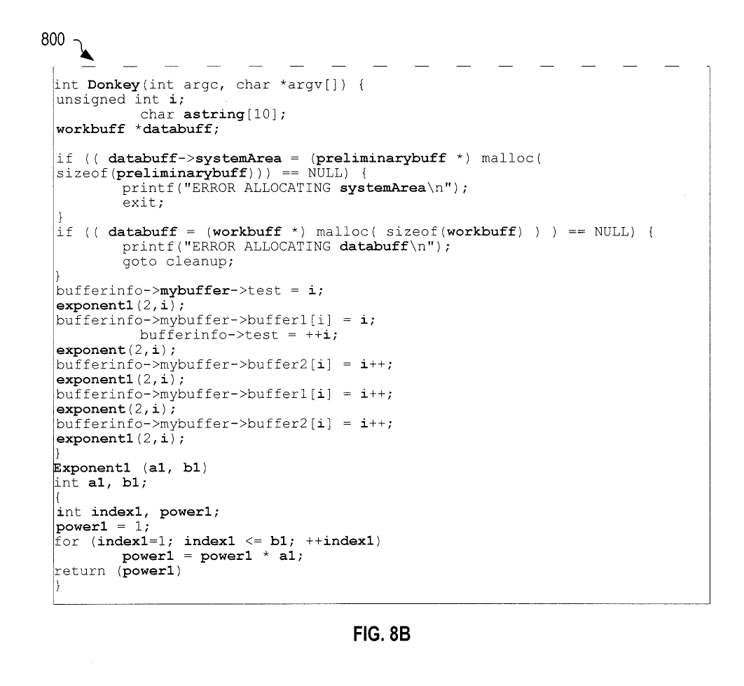

FIGS. 7A and 7B show exemplary first software source code 700 submitted to environment 100, FIG. 1, by a first developer as part of a first parallel processing routine. FIGS. 8A and 8B show exemplary second software source code 800 submitted to environment 100 by a second developer as part as a second parallel processing routine. In this example, the second developer has plagiarized first software source code 700, made changes to variable names, and rearranged the order of functions to form second software source code 800. Within FIGS. 8A and 8B, changes are shown in bold font for clarity of illustration.

Functionally, there is no difference between first software source code 700 and second software source code 800, however, this is not immediately apparent when comparing second software source code 800 to first software source code 700. Further, since the order of functions within second software source code 800 are re-ordered, as compared to the order of functions within first software source code 700, compiled code of second software source code 800 will differ from compiled code of first software source code 700; compiled code cannot be directly compared to identify plagiarism. In these examples, the ‘C’ language is case sensitive, and this requires the case of characters to match. Other software languages are case insensitive, and in embodiments supporting such languages, characters may be converted to all lower-case (or all upper-case) to ignore character case.

Environment 100 includes a plagiarism detection module (PDM) 109 for identifying plagiarism within submitted parallel processing routines (e.g., kernel 112 and algorithm 124). PDM 109 is illustratively shown within development server 108, however, PDM 109 may be implemented within other servers (e.g., program management server 110 and financial server 102) without departing from the scope hereof. PDM 109 may also be implemented as a separate tool for identifying software plagiarism external to environment 100.

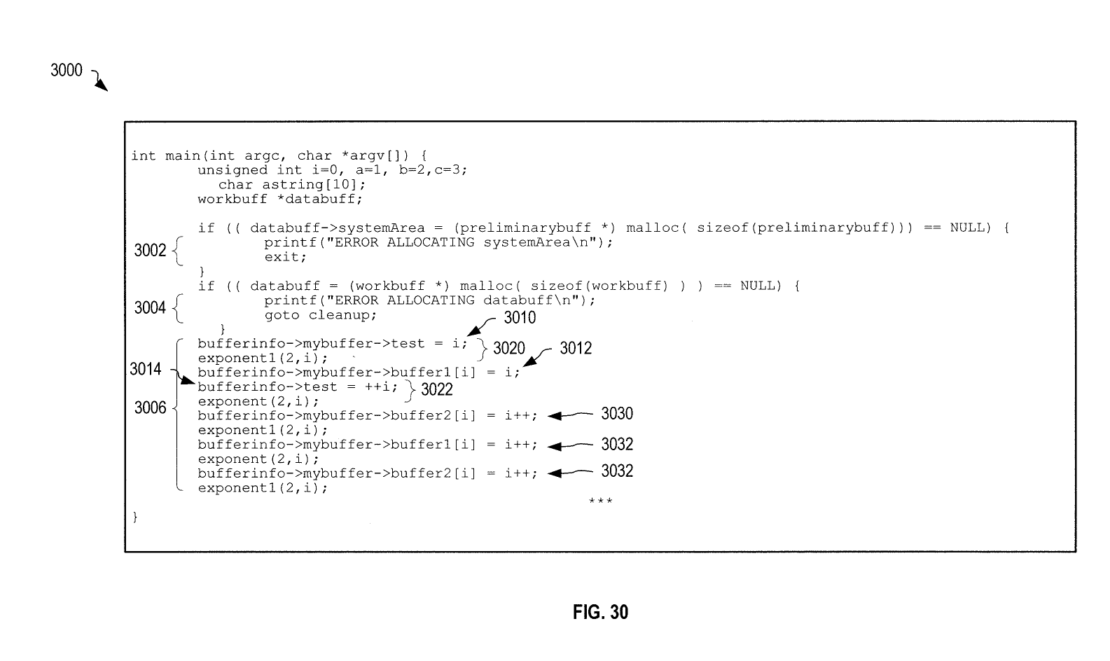

In a further example, an unscrupulous developer changes the order of independent statements within the software source code in an attempt to hide plagiarism. FIG. 30 shows a snippet of exemplary software source code 3000 to illustrate code blocks 3002, 3004 and 3006, independent statements 3010, 3012 and 3014, and dependent statements 3030, 3032 and 3034.

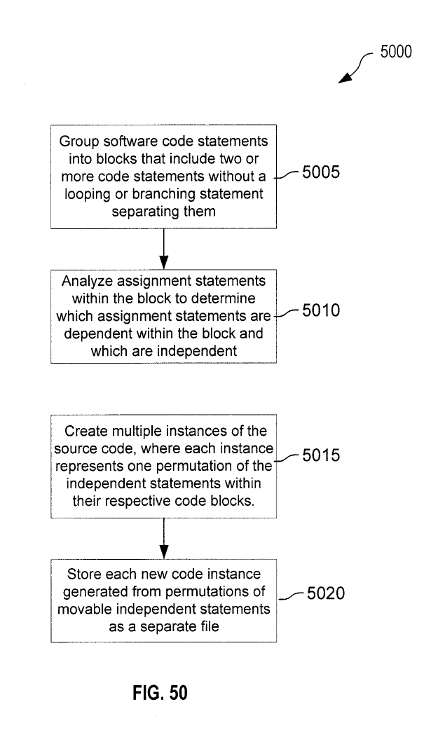

FIG. 50 is a flowchart showing an exemplary method for generating permutated multiple instances of code found in a software code statement. As shown in FIG. 50, at step 5005, groups of software code statements are grouped into blocks that include two or more code statements without a looping or branching statement separating them. In the ‘C’ language, examples of branching are: “goto . . . label”; “if . . . then . . . else . . . ”; “switch . . . case . . . default . . .”; “break”; and “continue”. In the ‘C’ language, examples of looping are: “for . . .”; “while . . .”; and “do . . . while . . .”.

At step 5010, assignment statements within the block are analyzed to determine which assignment statements are dependent within the block and which are independent. There are two types of assignment statements in the ‘C’ language: single-sided and two-sided. A single-sided assignment statement utilizes increment and decrement the operators, “++” and “−−”, respectively, in association with a variable. For example, “a++;” is an assignment statement that is equivalent to “a=a+1;”. A two-sided assignment statement includes one of the following operators: “=”, “/=”, “*=”, “+=”, “−=”, “&=”, “|=”, “̂=”, “<<=”, and “>>=”. For example, “a=a+1” is a two-sided assignment statement. The variable shown in the above single-sided assignment statement is considered as occurring on both the left and right side of the assignment. If a variable found in the right side of an assignment statement within a code block is also found on the left side of any preceding assignment statement (real or implied) within that same block, then that statement is considered dependent (e.g., dependent statements 3030, 3032 and 3034). Within the same block, any non-assignment statements following an assignment are considered associated (e.g., independent statements 3010 and 3012) with that assignment statement.

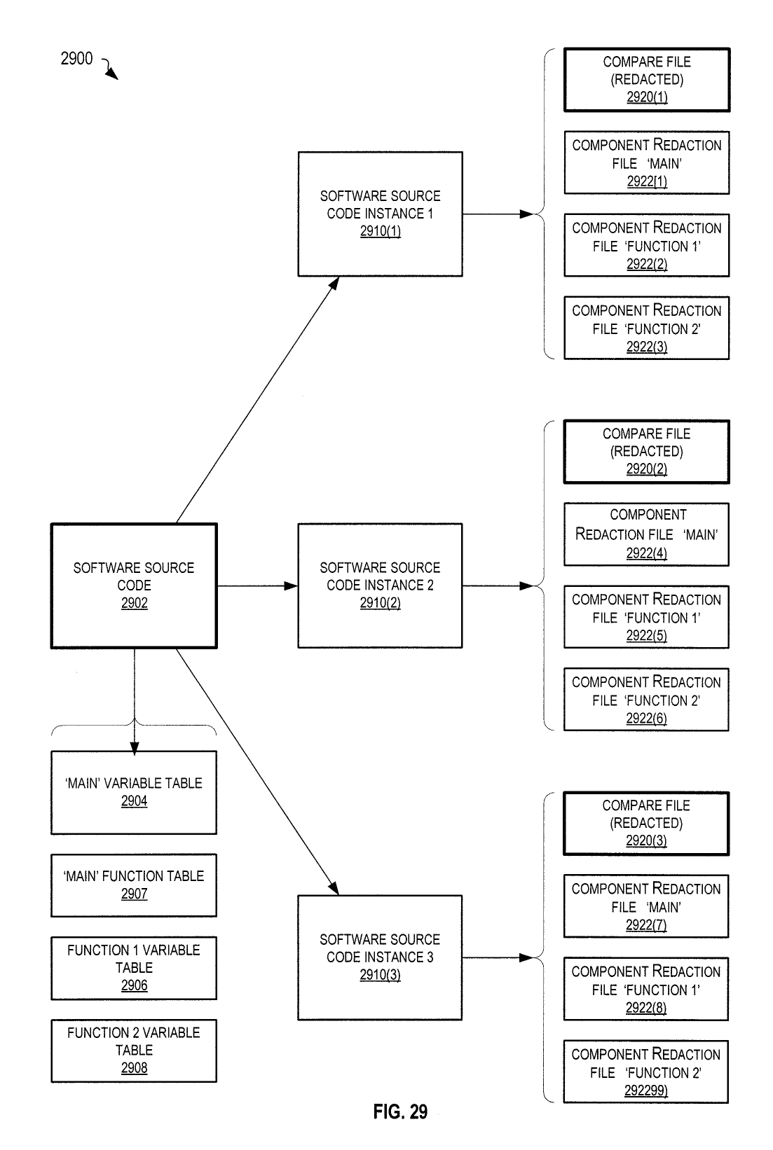

At step 5015, multiple instances 2910* (shown in FIG. 29, where “*” is a wild card indicating a specific instance) of the software source code are then created, while maintaining the same functionality as the original software source code, in accordance with the following rules.

Statements that are not determined as dependent within a block are considered independent statements and are placed, along with any associated statements, anywhere within a given code block, provided such placement does not change an independent statement into a dependent statement or change the dependency of a dependent statement (i.e., as long as the placement does not affect the dependency of any statements within the block). The dependency of a statement changes if an independent statement containing a variable on its left side (actual or implied) is exchanged for a statement that depends upon that left side variable. Dependent statements must occur after their defining independent statements. A dependent statement has no associated statements. Each software source code instance represents one permutation of the independent statements within their respective code blocks.

Looking at code block 3006 and at the above rules for positioning independent code statements, there is only one other permutation of the included statements. That is, independent statement 3010 and 3012 may exchange positions, but independent statement 3014 cannot move since the “++i” portion of the statement would cause either independent statement 3010 or independent statement 3012 to become dependent therefrom. Independent statement 3014 cannot exchange with any of dependent statements 3030, 3032, and 3034 since their dependence would be violated.

In one embodiment, at step 5020, each new code instance 2910* generated from permutations of movable independent statements is stored as a +“_#”+separate file using the following filename format: sourcefilename+”_#”+“.c(cpp)”, where “#” represents the instance number. For example, if the original software source code file is named “a.c”, the first new software source code instance filename is generated as “a_{—}1.c”.

FIG. 29 shows exemplary data generated from software source code 2902. Software source code 2902 may represent one or more of source code for kernel 122, FIG. 1, algorithm 124, kernel 204, FIG. 2, algorithm 202, parallel processing routines 404, FIG. 4, software source code 700, FIGS. 7A and 7B, and software source code 800, FIGS. 8A and 8B.

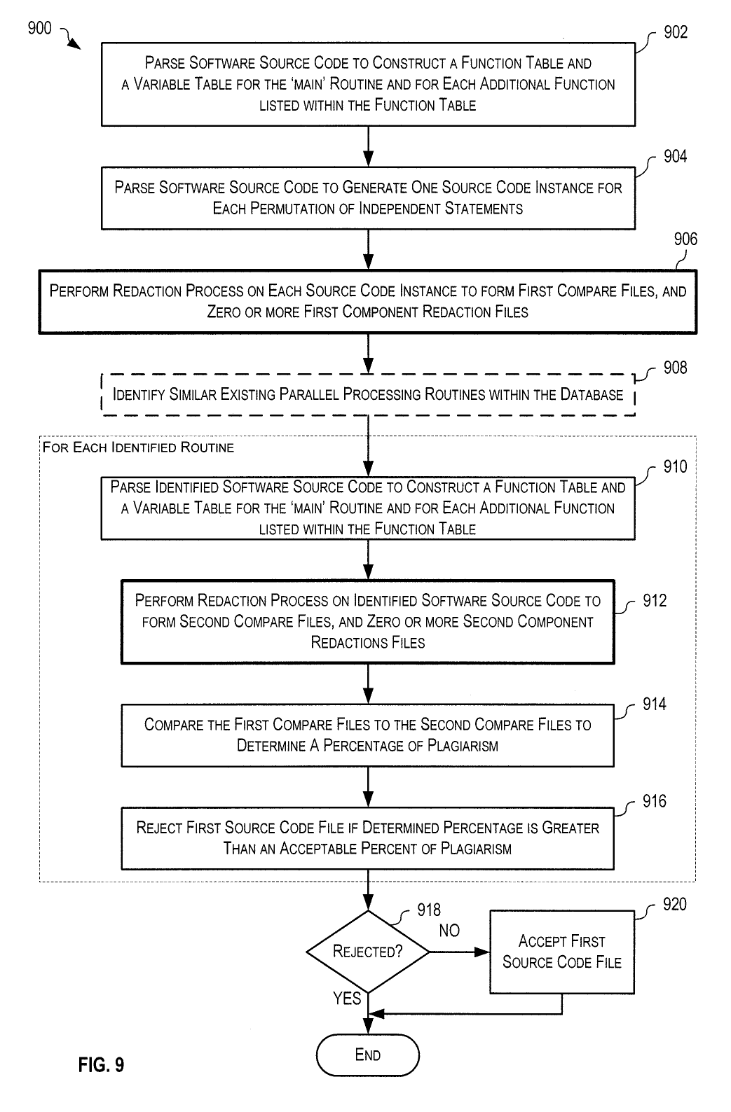

FIG. 9 shows one exemplary method 900 for determining the percentage of plagiarism in software source code. For example, a developer may submit a new parallel processing routine, such as kernel 122 and algorithm 124 of FIG. 1, to environment 100. Prior to publishing this new algorithm for use within environment 100, it is evaluated against existing parallel processing routines within environment 100 to ensure originality of the new routine. In view of the ease with which software source code may be altered to appear unique, the submitted software source code is compared, excluding variable names, filenames, and comments, to determine the amount of similarity to the existing routines.

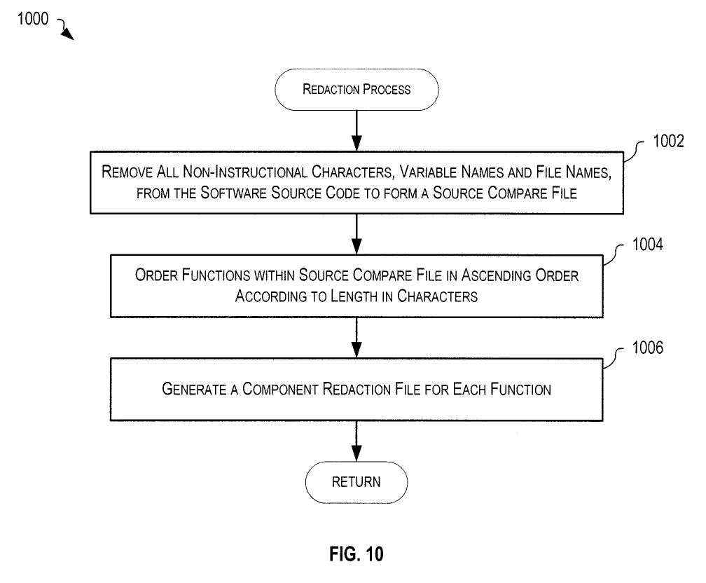

FIG. 10 shows one exemplary redaction process 1000 for redaction of software source code into redacted functional components. FIGS. 9, 10, and 29 are best viewed together in conjunction with the following description.

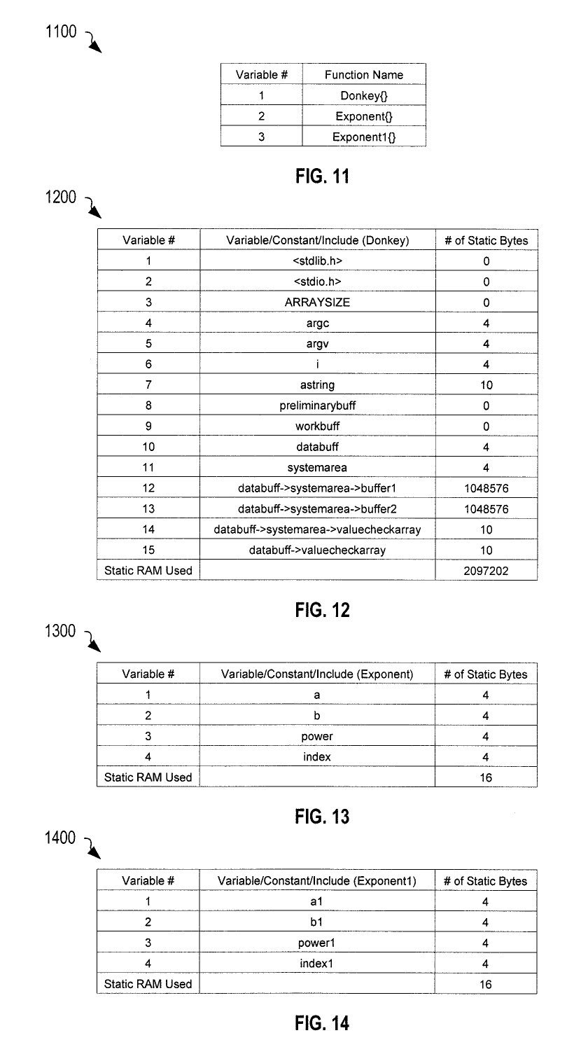

In step 902 of FIG. 9, as shown in shown in FIG. 29, software source code 2902 is parsed to construct a function name table 2907 and a variable table 2904 for the ‘main’ routine, and a variable table (e.g., 2906, 2908) for each additional function listed within the function name table. The function name table 2907 and variable tables 2904, 2906, 2908, etc., are subsequently used to identify functions for the purpose of generating component redaction files, as described below. The system searches for function names and variable names from the function name table and the variable table. When found within the text of a code to be tested for plagiarism they are removed (redacted) from the code prior to testing. In one example of step 902, PDM 109 parses software source code 800 to generate a function table 1100, FIG. 11, and to generate a variable table 1200, FIG. 12, for the ‘main’ function of the software source code, a variable table 1300, FIG. 13, for function ‘power’, and a variable table 1400, FIG. 14, for function ‘power1’.

In step 904, the software source code is parsed to generate one source code instance for each permutation of independent statements, as described above with respect to FIG. 50. In one example of step 904, PDM 109 parses software source code 2902 to generate software source code instances 2910(1), 2910(2), and 2910(3). In step 906, process 1000 (described in detail below with respect to FIG. 10) is invoked to redact each source code instance to create compare files and component redaction files. In one example of step 906, PDM 109 implements process 1000 to process software source code instance 2910(1) to generate source code compare file 2920(1), component redaction file ‘main’ 2922(1), component redaction file ‘function1’ 2922(2), and component redaction file “function2” 2922(3). Similarly, PDM 109 processes software source code instances 2910(2) and 2910(3) to generate compare file 2920(2), component redaction file ‘main’ 2922(4), component redaction file ‘function1’ 2922(5), and component redaction file ‘function2’ 2922(6), and compare file 2920(3), component redaction file ‘main’ 2922(7), component redaction file ‘function1’ 2922(8), and component redaction file ‘function2’ 2922(9), respectively.

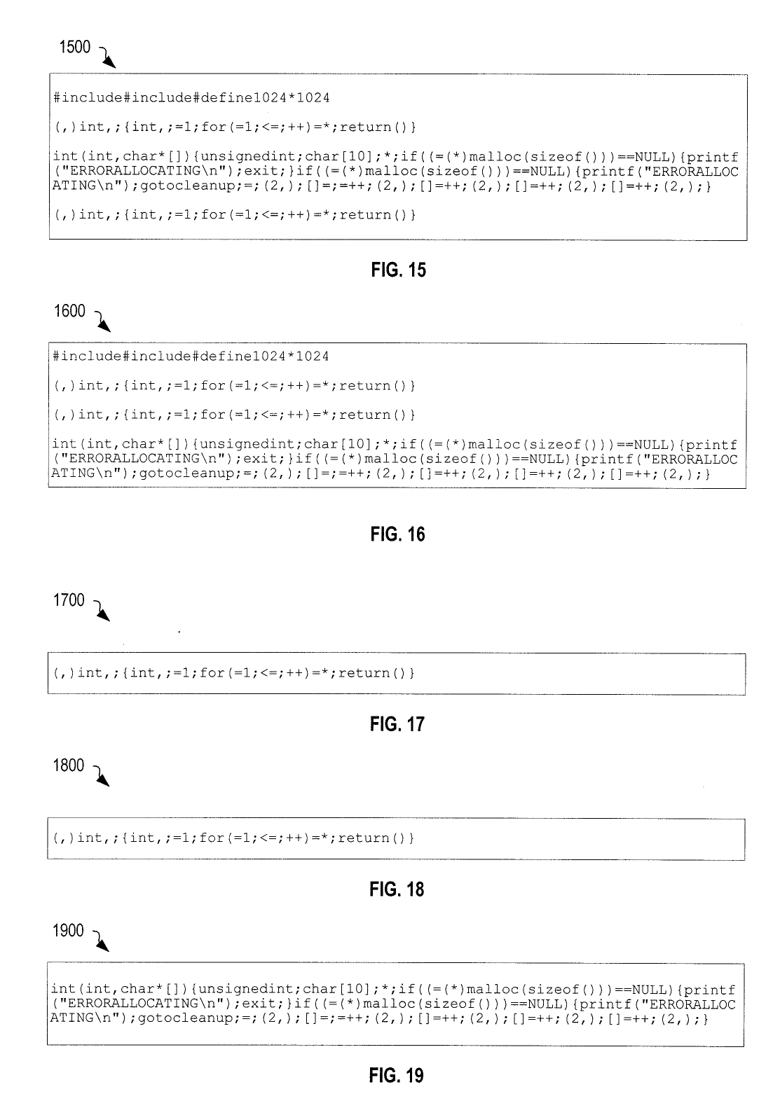

Process 1000 of FIG. 10 is now described in detail. In step 1002, all non-instructional characters, variable names and file names are removed from the software source code to form a source compare file. Non-instructional characters are ignored by the language compiler and may include formatting characters such as spaces, tabs, and line-feed/carriage-returns and comments. In one example of step 1002, PDM 109 removes formatting, comments, variable names, and file names from software source code 800 to form source compare file 1500, FIG. 15. Note that certain carriage-returns/linefeeds are left in source compare file 1500 for illustrational clarity of functional components.

In step 1004, functions within the source compare file are placed in ascending order according to length in characters. In one example of step 1004, PDM 109 determines the length in characters of each function within source compare file 1500 and places these functions in ascending size order, shown as source compare file 1600, FIG. 16.

In step 1006, a component redaction file 2922(*) is generated for each function within the source compare file. In one example of step 1006, PDM 109 creates a component redaction file 1700, FIG. 17, for first function ‘power’, a component redaction file 1800, FIG. 18, for second function ‘power1’, and a third component redaction file 1900, FIG. 19, for third function ‘main’.

Returning to method 900, FIG. 9, in step 908, similar existing parallel processing routines are identified within the database. In one example of step 908, PDM 109 searches database 106 to identify kernels (e.g., kernel 122) and algorithms (e.g., algorithm 124) that are similar to software source code 800 based upon category (e.g., category 206, FIG. 2) and/or associated keywords of software source code 800, and identifies software source code 700 of FIGS. 7A and 7B.

Steps 910 through 916 are repeated for each identified parallel processing routine of step 908.

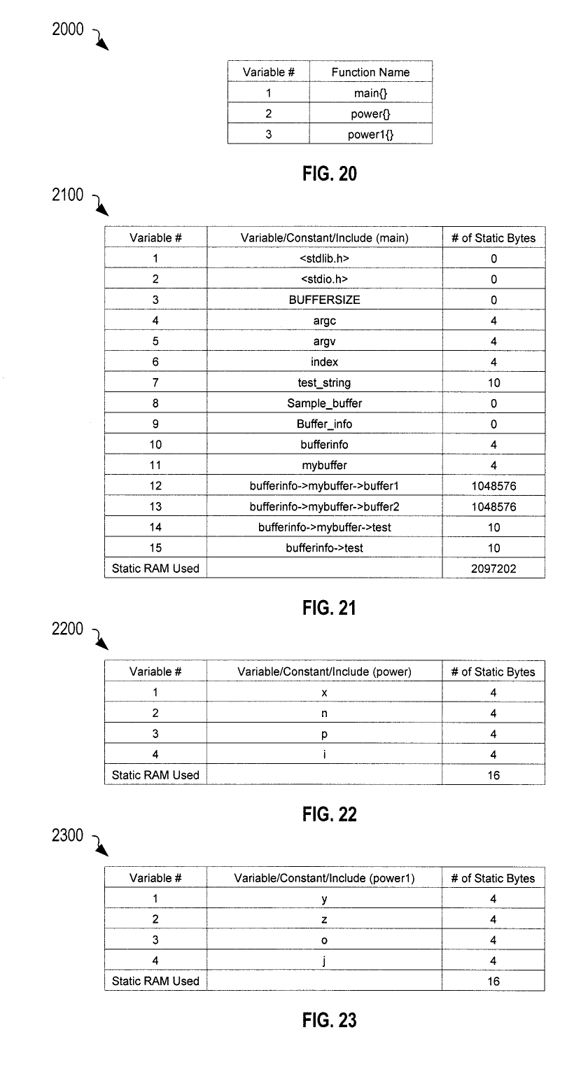

In step 910, the identified software source code is parsed to construct a function table and a variable table for the ‘main’ routine, and a variable table for each additional function listed within the function table. In one example of step 910, PDM 109 parses software source code 700 to generate second function table 2000, FIG. 20, second variable tables 2100 for first function ‘main’, 2200 for second function ‘power’, and 2300 for third function ‘power1’ as shown in FIGS. 21, 22, and 23, respectively.

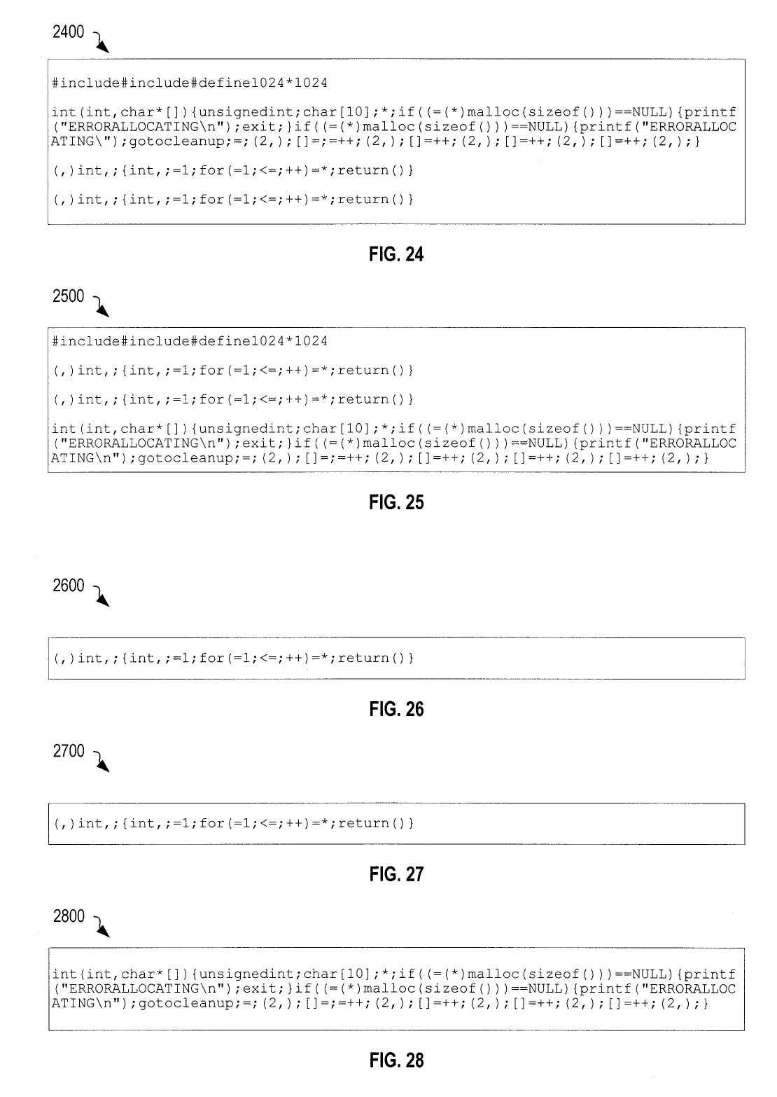

In step 912, process 1000 is invoked to perform redaction on identified software source code of step 908 to form second compare files and zero or more second component redaction files. In one example of step 912, PDM 109 implements process 1000 to process software source code 700 and generate source compare file 2400, FIG. 24, by removing formatting, comments, variable names, and file names from software source code 700. PDM 109 then utilizes process 1000 to order functions within source compare file 2400, FIG. 24, to form source compare file 2500, FIG. 25. PDM 109 then continues with process 1000 to generate: source compare file 2600, FIG. 26, for function ‘power’ of source code 700, source compare file 2700, FIG. 27, for function ‘power1’ of source code 700, and source compare file 2800, FIG. 28, for function ‘main’ of source code 700.

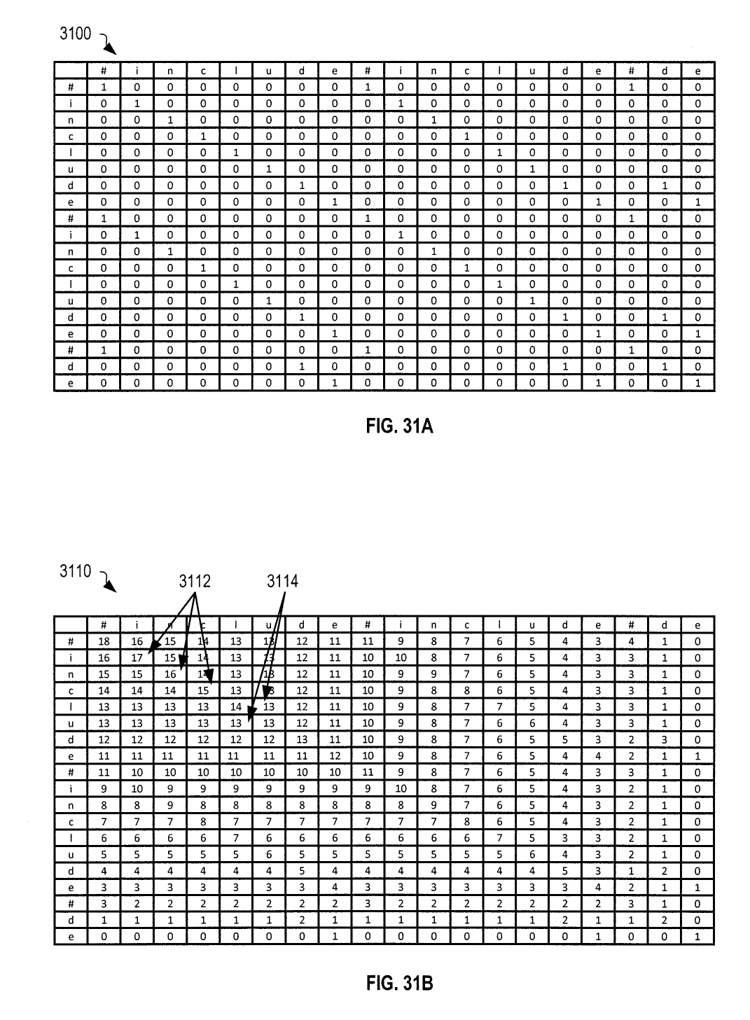

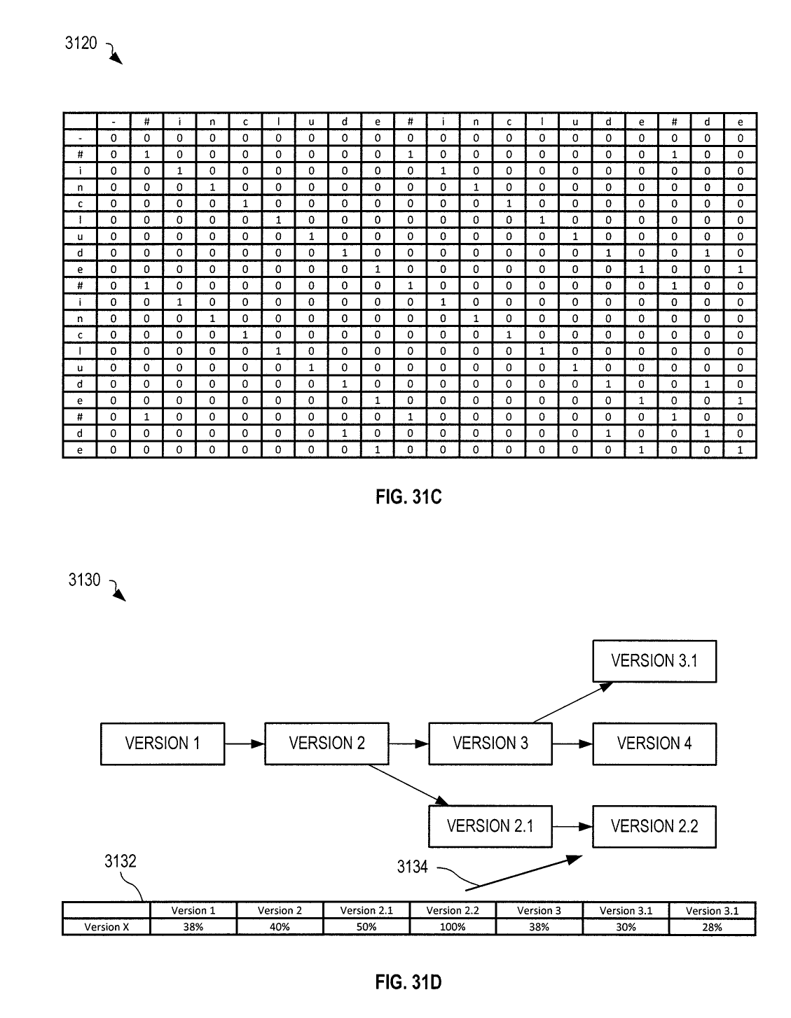

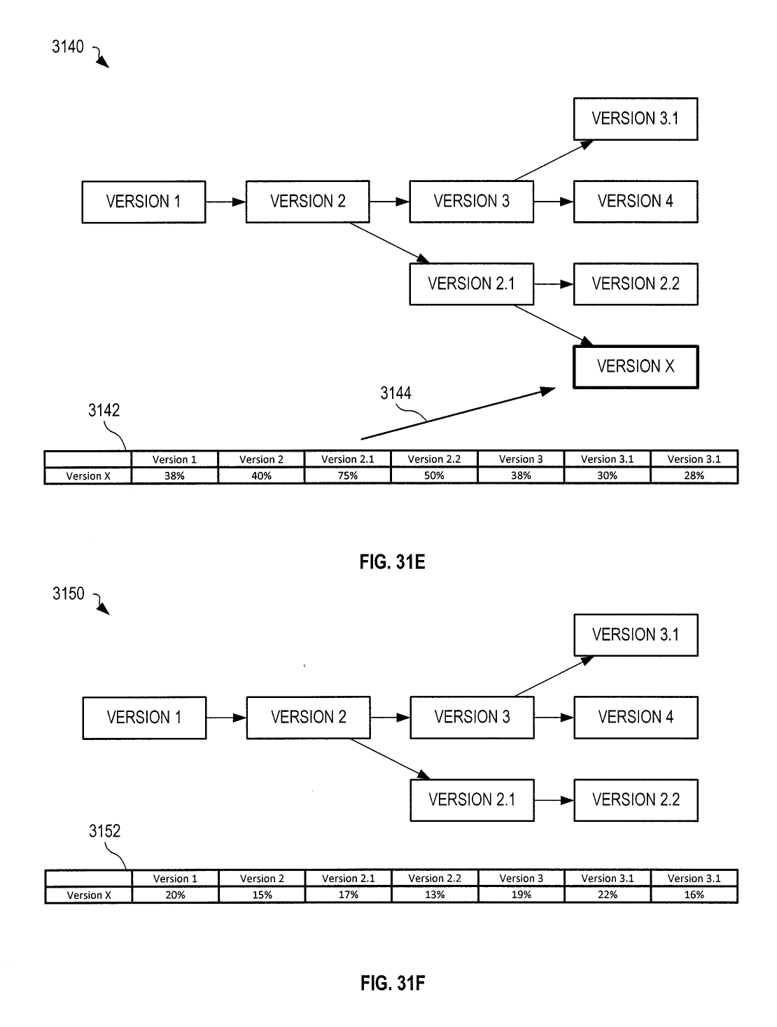

In step 914, the first compare files are compared to the second compare files to determine the percentage of plagiarism between code statements of the first source compare files and code statements of the second source compare files. In one example of step 914, PDM 109 utilizes a Needleman-Wunsch analysis to determine a percentage of plagiarism between (a) compare file 1600 and compare file 2500, (b) compare files 1700, 1800, 1900 and compare files 2600, 2700 and 2800, respectively. In particular, plagiarism percentages are determined for each instance 2910(1), 2910(2), and 2910(3) derived from software source code 800 against compare files 2500, 2600, 2700 and 2800. Source code alignment and plagiarism percentage determination is described in detail below, with reference to FIG. 31A.

In step 916, the first source code file is rejected if the determined plagiarism percentage is greater than an acceptable limit. In one example of step 916, PDM 109 has a defined limit of 60% and flags software source code 800 for rejection since determined plagiarism percentage is greater than 60%. PDM 109 may also send a rejection notice for software source code 800 to the associated developer 152.

Step 918 is a decision. If, in step 918, method 900 determines that the first source code file was not rejected in step 916 for any identified parallel processing routine within database 106, method 900 continues with step 920; otherwise, method 900 terminates. In step 920, the first source code file is accepted. In one example of step 920, software source code 2902 is accepted as not being plagiarized.

By utilizing method 900, each function may be evaluated against other functions stored in database 106 to determine a plagiarism percentage. Within software source code, functions may be considered a complete functional idea and are thus individually checked for plagiarism. As shown above, redacted code for each function is placed into its own file, called a component redaction file, which may have the file extension “.CRE”. Each component redaction file is compared against selected component redaction files within environment 100 (e.g., as stored within database 106). This process is similar to the process described in FIG. 9, wherein only component redaction files for each identified function are compared against component redaction files for other functions stored in database 106.

Plagiarism—Alignment Step

Software is typically created in versions, with one version including many of the features of a previous version. That is, there may be an evolutionary relationship between versions of code. Based upon this evolutionary relationship, bioinformatics mathematical tools may be used to determine a closest version of tested code to a newly submitted software source code. Using the Needleman-Wunsch dynamic programming model, it is possible to obtain all optimal global alignments between two redacted files (e.g., component redaction file 2922(1) and component redaction files 2922(4)-2922 (9)). The Needleman-Wunsch equation is as follows:

M_{i,j}=M_{i,j}+max(M_{k,j+1},M_{i+1,l})

Where:
Mi,j=the completed redacted codes to be compared
i=the length of the first file
J=the length of the second file
k=any integer>i
l=any integer>j

FIG. 31A shows one exemplary table 3100 illustrating matching between the first 19 characters of each of source compare file 1600, FIG. 16, and source compare file 2500, FIG. 25. The shown technique is directly applicable to each entire redacted file. Within table 3100, a top row represents source compare file 1600 and a left column represents characters of source compare file 2500. As shown in FIG. 31A, where characters match between files 1600 and 2500, a 1 is placed within a corresponding square. FIG. 31B shows an exemplary table 3110 resulting from the application of the Needleman-Wunsch equation to the table 3100 of FIG. 31A. Specifically, the Needleman-Wunsch equation is applied repeatedly to form table 3110. A primary optimal trace 3112 of nineteen consecutively matched characters is found, and secondary optimal traces 3114 are also identified.

Using a Smith-Waterman dynamic programming model, it is possible to obtain all optimal local alignments between two source compare files (e.g., compare files 1600 and 2500). The Smith-Waterman dynamic programming model, as described here, is considered the preferred alignment method because it allows the effects of gaps in the compared sequences to be weighted. The equations below show the Smith-Waterman dynamic programming model:

$$H ( i , 0 ) = 0 , 0 \leq i \leq m$$

$$H ( 0 , j ) = 0 , 0 \leq j \leq n$$

$$H ( i , j ) = max \{ \begin{matrix}0 & \\ \begin{matrix}H ( i - 1 , j - 1 ) + \\ w ( {a}_{i} , {b}_{j} )\end{matrix} & Match / Mismatch \\ H ( i - 1 , j ) + w ( {a}_{i} , - ) & Deletion \\ H ( i , j - 1 ) + w ( - , {b}_{j} ) & Insertion\end{matrix} \} , \\ 1 \leq i \leq m , 1 \leq j \leq n$$

### Where:

a, b=Strings over the Alphabet Σ
m=length(a)
n=length(b)
H(i,j)=the maximum Similarity-Score between a suffix of a[1 . . . i] and a suffix of b[1 . . . j]
ω(c,d), c,d εΣ∪{‘-’}, ‘-’ is the gap-scoring scheme

Example:
Sequence 1=first 19 characters of code snippet A
Sequence 2=first 19 characters of code snippet B
w(match)=+2
w(a,−)=w(−,b)=w(mismatch)=−1

FIG. 31C shows an exemplary Smith-Waterman dot table 3120 illustrating provisions for gap detection identified by “-” characters within the table. It should also be noted that the BLAST or any other local alignment method may also be used to create the optimal traces required in this step.

Plagiarism—Compare Step

The greater the number of matched characters found in two codes used to generate filtered, optimally aligned traces, the lower the probability that those codes are unaffiliated. If the compared codes generate matches long the filtered, optimally aligned trace above 25% then homology may be assumed; that is, the codes are evolutionarily related. Therefore, 25% character matches along any filtered, optimally aligned trace by any two codes (called A and B, with A=the code being tested for plagiarism) constitutes plagiarism of A against B.

Determining Code Lineage

Since software source code is generally created in versions, with one version conserving many of the features of the previous version, where there are multiple versions of the code then some version of code will have a higher percentage of matches in the filtered aligned trace to another version closest in lineage. For example, if an unknown software source code (version X) is compared against software source code versions that are evolutionally related, then the following scenarios may occur.

FIG. 31D shows a first exemplary scenario 3130 wherein a plagiarism percentage of version X against each of versions 1, 2, 2.1, 2.2, 3, 3.1, and 4 is determined as shown in table 3132. A 100% match of version X against version 2.2 indicates that version X is version 2.2, as indicated by arrow 3134.

FIG. 31E shows a second exemplary scenario 3140 wherein a plagiarism percentage of version X against each of versions 1, 2, 2.1, 2.2, 3, 3.1, and 4 is determined as shown in table 3142. A 75% match of version X against version 2.1 indicates that version X is probably derived from version 2.1, as indicated by arrow 3144, but is not the same as version 2.2.

FIG. 31F shows a second exemplary scenario 3150 wherein a plagiarism percentage of version X against each of versions 1, 2, 2.1, 2.2, 3, 3.1, and 4 is determined as shown in table 3152. Plagiarism percentages within table 3152 indicate no evolution, and therefore no plagiarism, between version X and versions 1, 2, 2.1, 2.2, 3, 3.1, and 4.

Code-creation time-stamps may also be used in place of version numbers to show the association of some unknown code such as version X.

Malicious Software Behavior Detection

Within environment 100, parallel processing routines (e.g., kernels 122 and algorithms 124), should not cause problems to other parallel processing routines. Software that causes problems to other software is called malicious software, and the unwanted software activity is called malicious software behavior. Malicious software behavior may occur accidentally or may be intentional. In either event, malicious software behavior is undesirable within environment 100. Preferably, malicious software is detected prior to publication of that software (e.g., parallel processing routine) within environment 100.

One exemplary malicious software behavior is when a variable (e.g., an array type structure or pointer) in memory overflows and protected memory is accessed. A hacker (i.e., a person that intentionally creates malicious software) attempts to gain unauthorized access to protected memory of a system and then exploit that access.

To prevent malicious software behavior within environment 100, development server 108 includes a malicious behavior detector (MBD) 111. Specifically, MBD 111 functions to detect malicious behavior within parallel processing routines submitted for publication within environment 100. MBD 111 detects malicious software behavior in submitted parallel processing routines, and detects when a parallel processing routine is overflowing its variables.

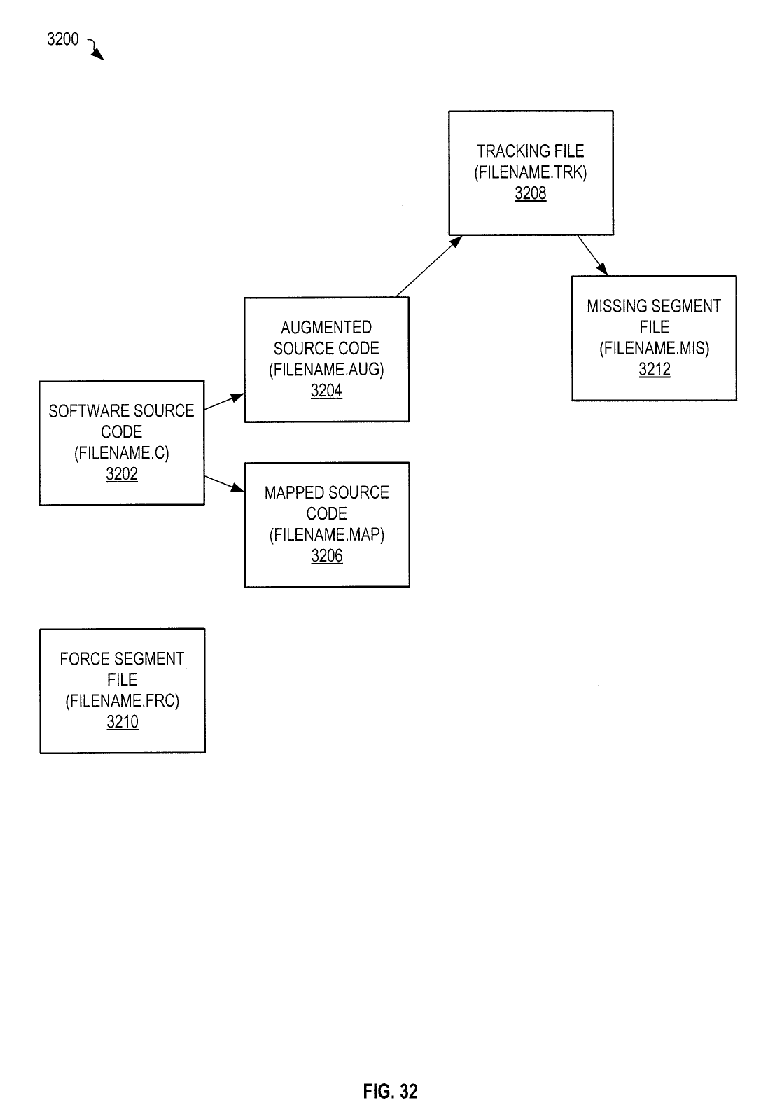

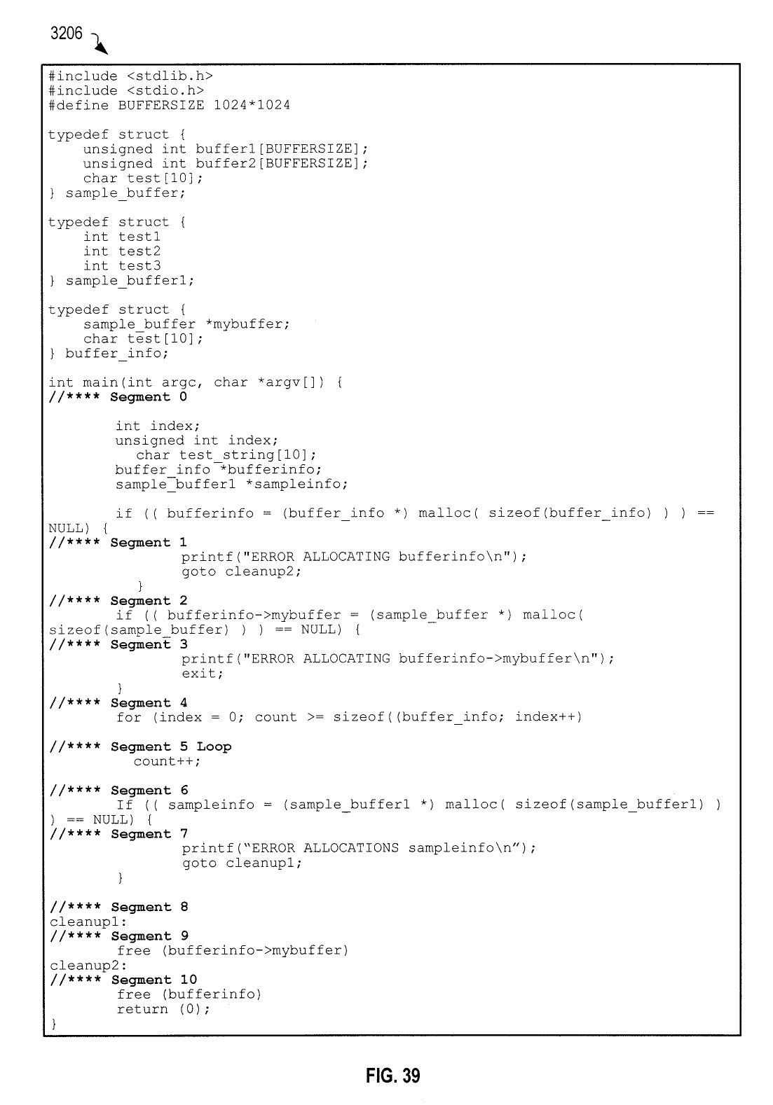

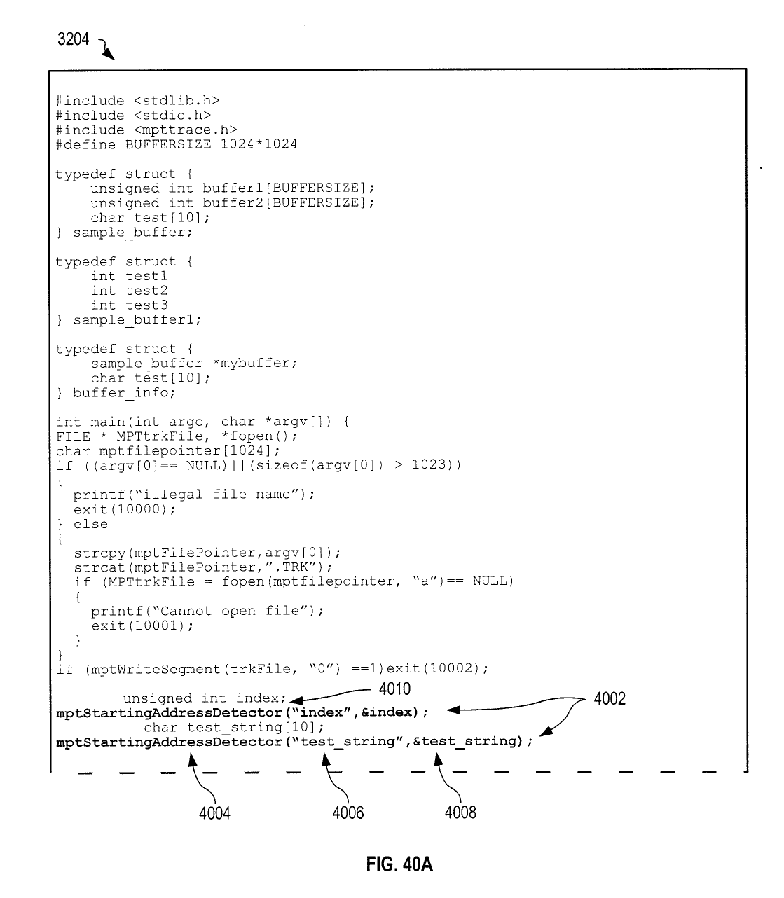

FIG. 32 shows exemplary files used by MDB 111 when detecting malicious software behavior within software source code 3202. In a first step, MBD 111 creates augmented source code 3204, which is a copy of software source code 3202, with the same filename as the original software source code and with an “.AUG” extension. Similarly, MBD 111 also creates mapped source code 3206, which is a copy of the software source code, with the same filename as the software source code and with a “.MAP” extension. Augmented source code 3204 and mapped source code 3206 are amended to include comments indicating a segment number for each identified linear source segment. To ensure that the software source code is fully tested, all identified linear code segments within the software source code must be activated during the test. Since certain branches within software source code 3202 may only be activated upon one or more error conditions, selection of these branches may be forced. Mapped source code 3206 may be returned to the developer (or submitter) of software source code 3202 as a reference when un-accessed segments are reported during testing. Mapped source code 3206 is exemplified in FIG. 39.

Identifying linear source code segments within the software source code allows the software to be iteratively tested when not all linear code segments can be tested in a single run. MBD 111 further modifies augmented source code 3204 to output tracking information from each linear code segment into a tracking file 3208 with the same filename as the software source code and a “.TRK” extension. A parallel processing routine associated with software source code 3202 is not published for use by the present system until all branches and looped code segments have been tested as indicated by tracking information within tracking file 3208.

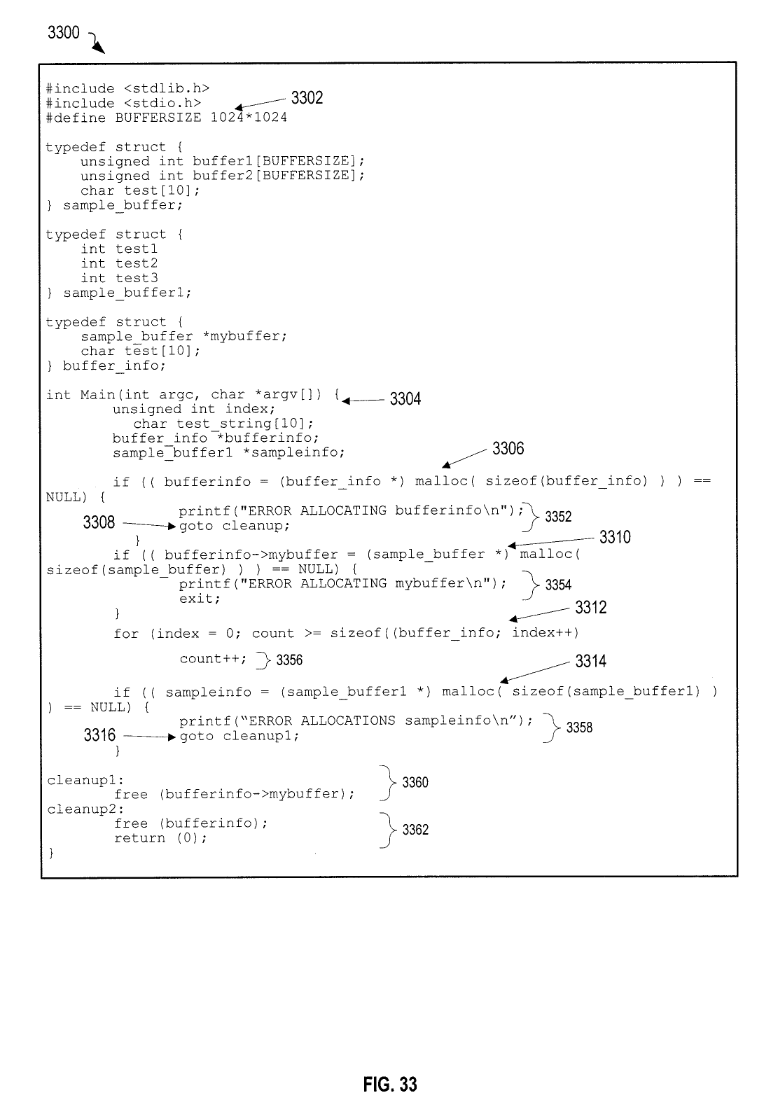

FIG. 33 shows exemplary software source code 3300 as submitted to environment 100 by developer 152. Software source code 3300 may represent software source code 3202, FIG. 32.

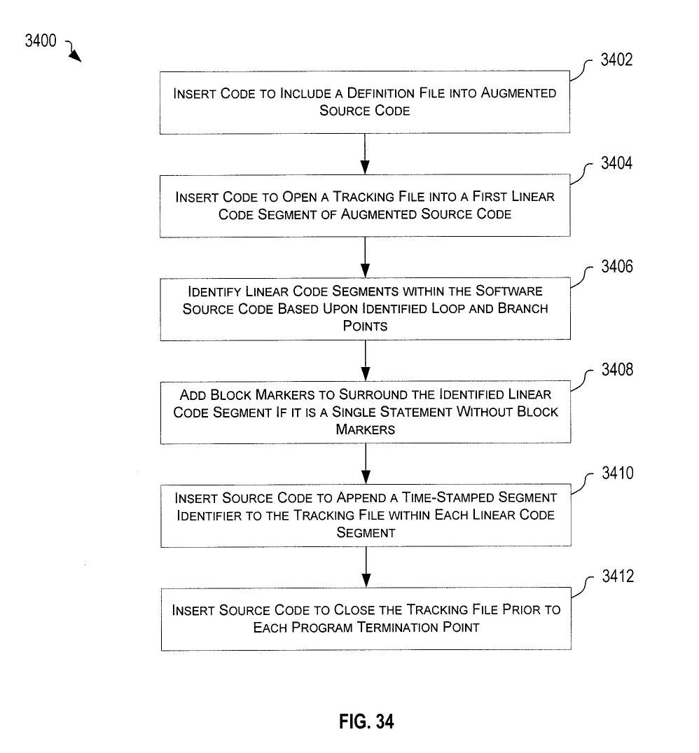

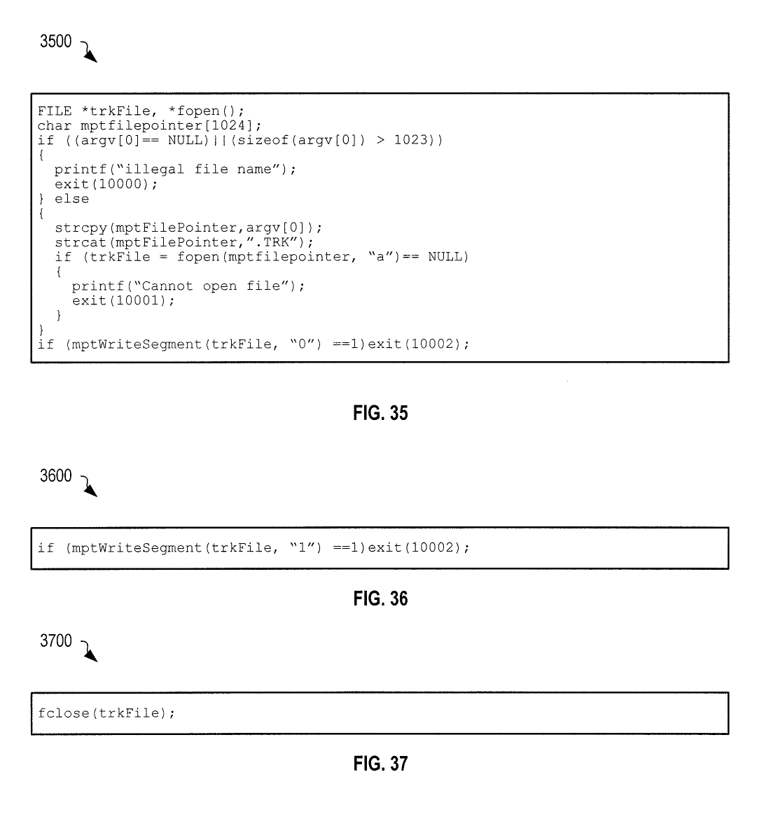

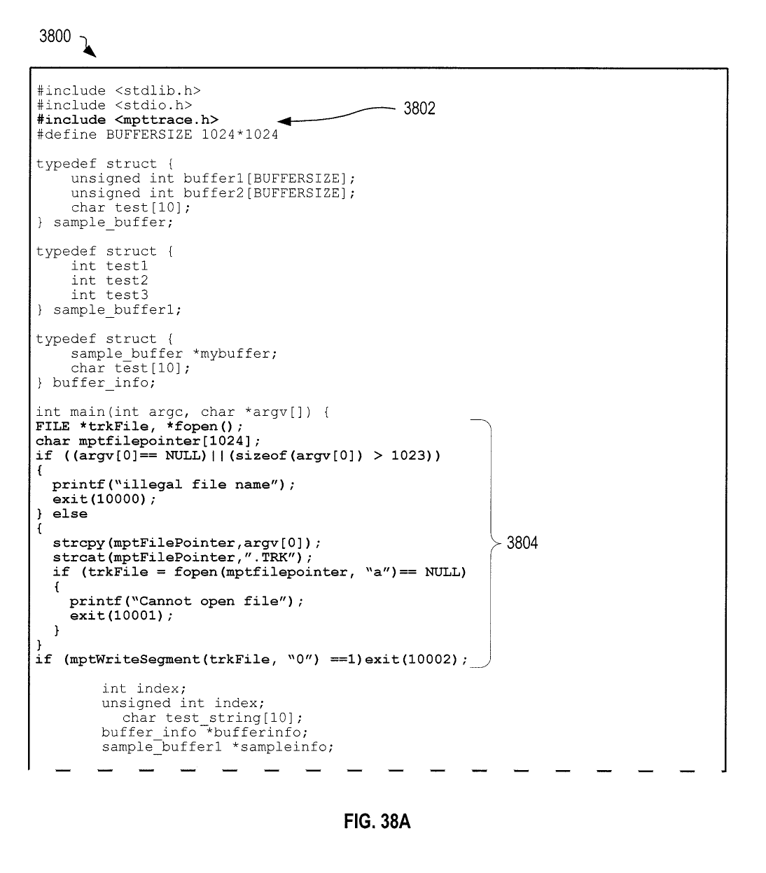

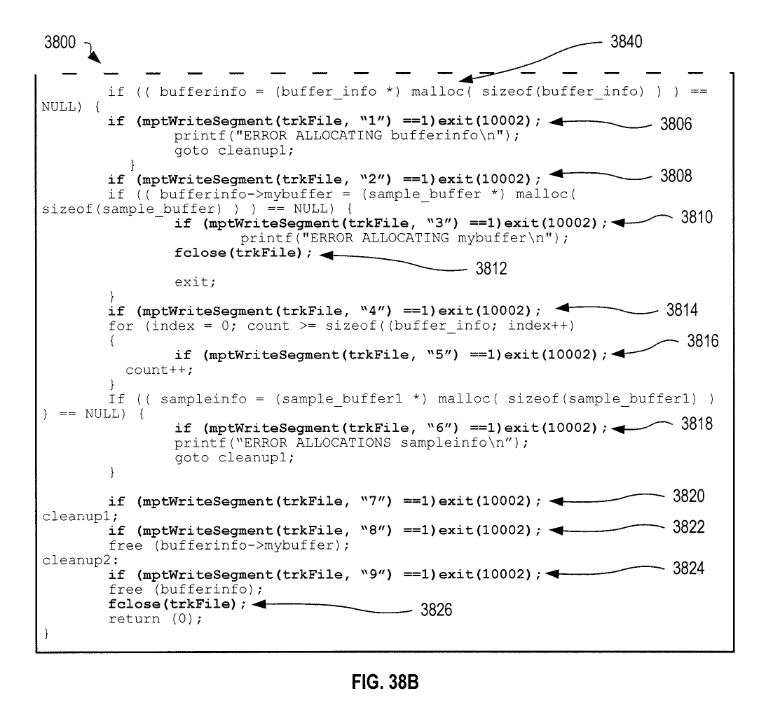

FIG. 34 shows one exemplary process 3400 for amending software source code 3202 to form augmented source code 3204. Process 3400 is implemented as machine readable instructions within MBD 111, for example. FIG. 35 shows one exemplary code insert 3500 for creating and opening tracking file 3208. FIG. 36 shows one exemplary code insert 3600 that calls a function “mptWriteSegment( )” to append a current date and time and segment number to tracking file 3208. FIG. 37 shows one exemplary code insert 3700 for closing tracking file 3208. FIGS. 38A and 38B show exemplary code inserts within software source code 3300. FIGS. 34, 35, 36, 37 and 38 are best viewed together with the following description.

In step 3402, process 3400 inserts code to include a definition file into an augmented source code. In one example of step 3402, MBD 111 inserts “#include <mpttrace.h>” at point 3302 of software source code 3300 to include definitions that support tracking code that will also be inserted into augmented source code 3204. In step 3404, process 3400 inserts code to open a tracking file into a first linear code segment of the augmented source code. In one example of step 3404, MBD 111 inserts code insert 3500, FIG. 35, into software source code 3300 at point 3304, which is at the start of a first linear code segment of the first executed function (“main”) of software source code 3300. In step 3406, process 3400 identifies linear code segments within the software source code based upon identified loop and branch points. In one example of step 3406, MBD 111 parses software source code 3300 and identifies branch points 3306, 3308, 3314 and 3316, and loop point 3312, to identify linear code segments 3352, 3354, 3356, 3358, 3360, and 3362 therein.

In step 3408, process adds block markers to surround the identified linear code segment if it is a single statement without block markers. In one example of step 3408, MBD 111 adds delimiters “{” and “}” around linear code segment 3356. In step 3410, process 3400 inserts source code to append a time-stamped segment identifier to the tracking file within each linear code segment. In one example of step 3410, MBD 111 adds code to call a function ‘mptWriteSegment (trkFile, “X”)’, where X is the segment number, as a first statement within each identified linear code segment 3352, 3354, 3356, 3358, 3360, and 3362. The function ‘mptWriteSegment’ writes the current time and date, and the segment number X to the end f the already opened tracking file, ‘trkFile’. In step 3412, process 3400 inserts source code to close the tracking file prior to each program termination point. In one example of step 3412, MBD 111 adds code insert 3700, FIG. 37, prior to each ‘exit’, ‘_exit’, and ‘return’ statement, as shown by inserts 3812 and 3826.

In addition, the “mptWriteSegment” function determines if execution time of previous segments, and/or the total execution time, exceeds a defined maximum time. If the defined maximum time limit has been reached, the “mptWriteSegment( ) function returns a 1; otherwise, it returns a 0. As shown in code insert 3600, FIG. 36, an ‘if’ statement evaluates the returned value from the “mptWriteSegment( ) function and may cause the parallel processing routine to terminate prematurely.

FIG. 39 shows exemplary comment inserts (shown as bold text) within mapped source code 3206, based upon software source code 3300.

Tracing Kernel Data Usage—Level 2 Augmentation

Computer languages may have different static and dynamic memory allocation models. In the C and C++ languages, dynamic memory is allocated using “malloc ( )”, “calloc ( )”, “realloc ( )”, and “new type ( )” commands. Arrays may also be dynamically allocated at runtime. The allocated memory utilizes heap space. Unless the allocation is static, it is created for each routine in each thread. The C language includes the ability to determine a variable address and write any value starting at that address. To ensure that memory outside of the memory allocated to the routine is not accessed (e.g., by writing more values to a variable than that variable is defined to hold, which is a standard hacker technique), all variables, static and dynamic, are located and their addresses are checked at runtime for overflow conditions.

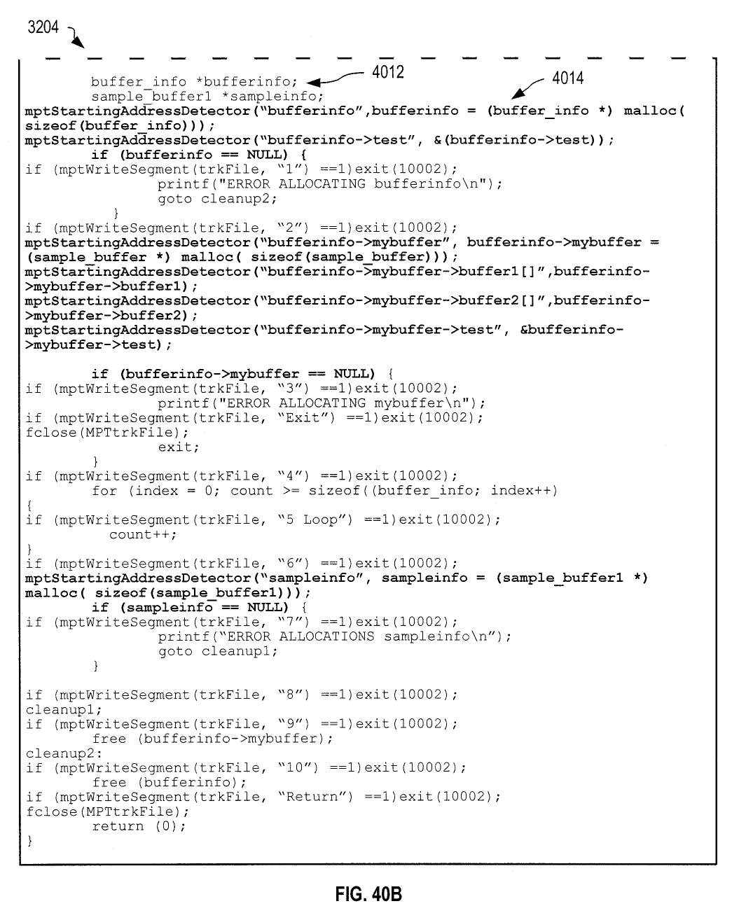

To identify code that will access memory beyond the defined extent of a variable, the starting and ending addresses of each variable is determined at runtime. FIGS. 40A and 40B show exemplary placement of variable address detection code 4002 within augmented source code 3204 to determine the starting address of variables at run time. Variable address detection code 4002 is added to augmented source code 3204 after each variable definition. In FIGS. 40A and 40B, added code is shown in bold for clarity of illustration. In the example of FIG. 40A, variable address detection code 4002 is implemented as a function 4004 “mptStartingAddressDetector( )” with two input parameters: variable name string 4006 and variable address 4008. The variable name string is the name of a variable or a constructed variable enclosed by quotes. The address parameter is the address of the variable. In the C language example of FIG. 40A, “mptStartingAddressDetector(“index”, &index);” is added to augmented source code 3204 after the declaration of the variable “index” at position 4010.

If a pointer is declared, as shown at position 4012 of FIG. 40B, it is typically assigned a value (i.e., an address of a memory area) with an assignment statement. In the C language for example, the following functions are used to allocate memory to a pointer: “alloc”, “calloc”, “malloc”, and “new”. If a storage allocation function is on the right side of an assignment statement, then a pointer on the left side of the assignment is being allocated memory within the statement, as shown at position 3840 of FIG. 38B. The “mptStartingAddressDetector( )” function is used to capture the starting address assigned to the pointer, as shown at position 4014. In the C language, the following are assignment operators: =, +=, −=, *=, /=, %=, <<=, >>=, &=, ̂=, and |=.

When required, allocation of memory to the pointer is isolated, such as from within an “if” statement as shown at position 3840. The assignment of the memory and the evaluation of the pointer resulting from the allocation are separated, as shown at position 4014, to allow the variable address detection code 4002 (e.g., function “mptStartingAddressDetector( )”) to record the start address, and the test of the allocated pointer is performed within a separate “if” statement as shown.

The starting address is obtained as follows:
All type definitions for non-struct variables are located.
When found, obtain the addresses of those variables using the mptStartingAddressDetector ( ) function.
If a pointer definition occurs using a storage allocation function then isolate its assignment statement and obtain the new address using the mptStartingAddressDetector ( ) function.
Whenever an assignment operator is encountered without a storage allocation function, when the address of a variable is used to calculate an address, or when the address of a variable is changed then the current address of the variable on the left side of the assignment operator (actual or implied) is captured using the “currentAddressDetector( )” function. For example, the following C language statement increments a pointer value:
   ++bufferinfo;

To evaluate the pointer value at run time, a function is inserted after the statement changing the pointer value as follows:
++bufferinfo;
mptCurrent AddressDetector(”bufferinfo“, bufferinfo);

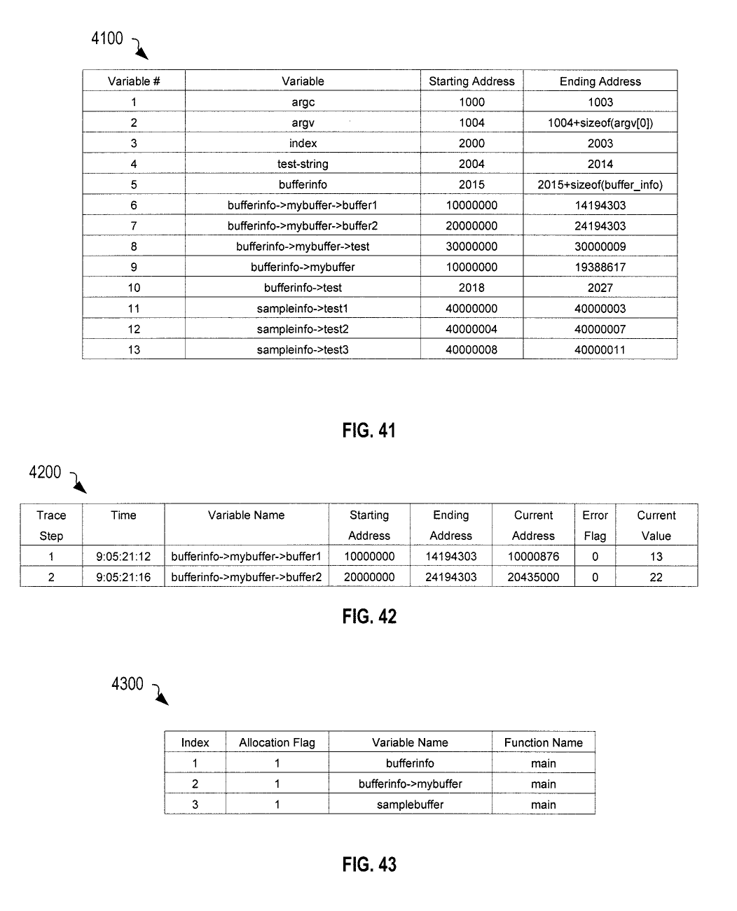

In this example, the function “mptCurrentAddressDetector( )” compared the modified pointer value against the determined starting and ending address values as previously determined by the “mptStartAddressDetector( )” function and stored within a variable tracking table 4100 of FIG. 41. In particular, the pointer value, as determined by the “mptCurrentAddressDetector( )” function, is compared against that variable's valid address range and results of that comparison are written to tracking file 3208. FIG. 42 shown one exemplary table 4200 illustrating output of the “mptCurrentAddressDetector( )” function.

Tracking Memory Allocations And Deallocations

As noted above, memory is typically assigned to a pointer using an allocation function within the language. In the C language, memory is allocated using a malloc, calloc, realloc, or new system function call. To record these memory allocations, an allocation tracking function is added to augmented source code 3204 proximate to the assignment to the pointer, to write the name of the variable on the left side of the memory allocation assignment into an allocated resources table.

FIG. 43 shows one exemplary allocated resources table 4300 containing a variable name of the pointer that has been allocated, a name of the function in which it was allocated, and an allocation flag. The allocation flag is set to one when the associated variable has memory allocated to it and is set to zero when no memory is allocated to the variable (e.g., when the allocated memory has been freed). One example of a function for tracking the allocation and deallocation of memory is shown below:
mptAllocationTableChange(”variable name“, “function name”, allocation flag);

Proximate to each memory allocation and assignment to a pointer variable within augmented source code 3204, a call to the “mptAllocationTableChange( )function, with a one as the third parameter, updates allocated resources table 4300 to indicate that memory has been allocated to that pointer variable. Similarly, for each memory de-allocation statement of augmented source code 3204, a call to the “mptAllocationTableChange( ) function is inserted with a zero as the third parameter to record the memory deallocation to the pointer variable of the statement. Where memory is allocated to pointer already listed within allocated resources table 4300 (e.g., memory is allocated to a pointer variable more than once), an additional entry with the same variable name is added to allocated resources table 4300.

When memory is deallocated from the pointer variable, the first entry in allocated resources table 4300 that matches the variable name and function name, and has the allocation flag set to one, is modified to have the allocation flag set to zero. Allocated resources table 4300 thereby tracks allocation and deallocation of memory, such that abnormal use of allocated memory (e.g., where memory is allocated twice to a pointer variable without the first memory being deallocated) can be determined. Similarly, address assignments (e.g., a memory address stored within one pointer variable assigned to a second pointer variable) are tracked to prevent miss-use of allocated memory.

At every program termination point (e.g., a return or exit function call within the C language), the allocation resource table values are stored in tacking file 3208. Below shows the function required to perform the allocation resource table value tracing augmentation.
mptTraceResourceValue (sourceFileName.TRC file handler);

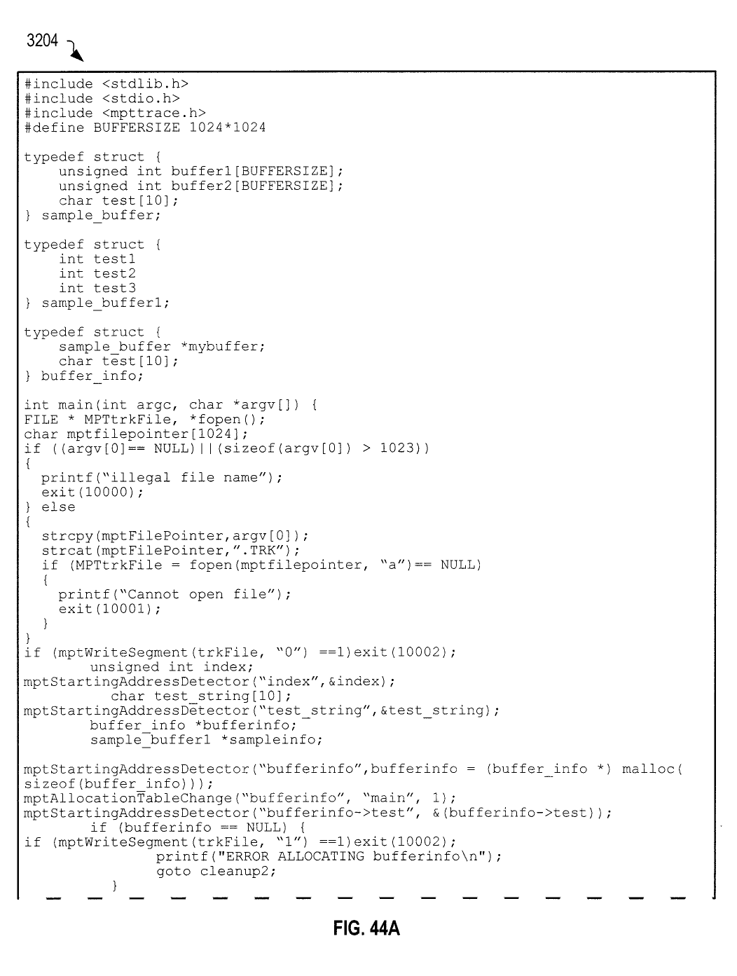

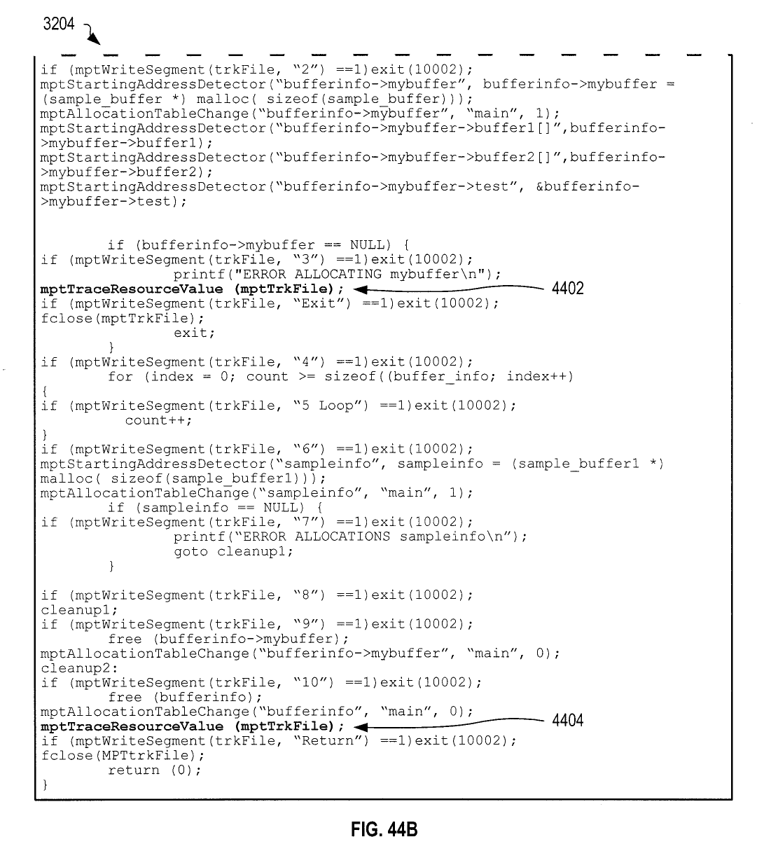

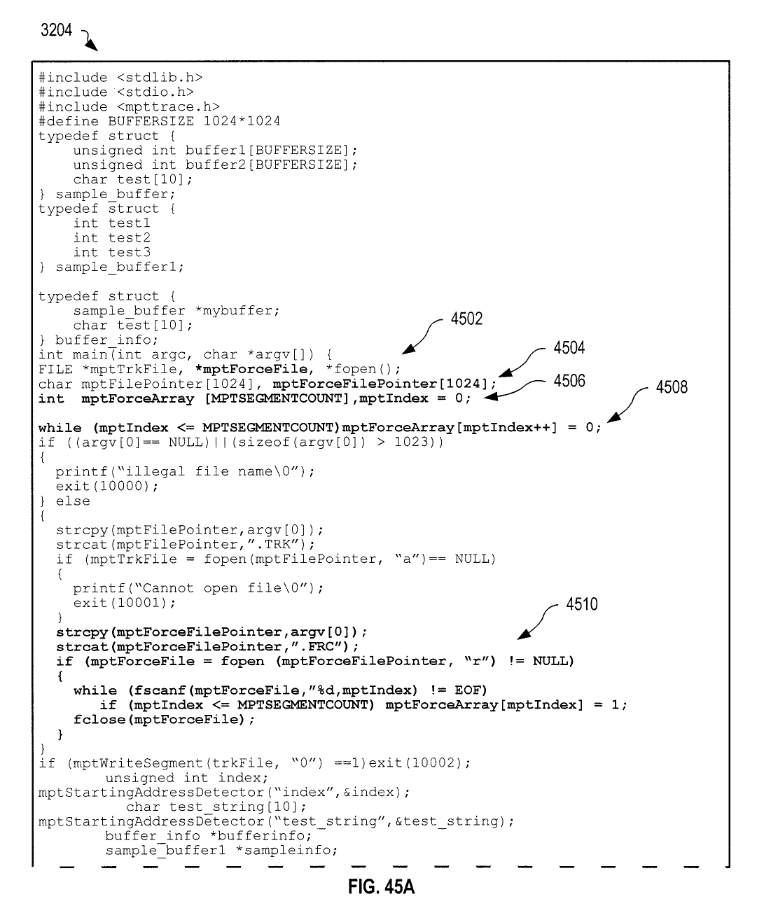

FIGS. 44A and 44B show exemplary additions 4402 and 4404 of mptTraceResourceValue( )functions to augmented source code 3204.

Forced Code Segment Entry—Level 3 Augmentation

Accessing certain code segments within software source code 3202 may be problematic in that they are typically accessed only upon certain error conditions. Where code segments are not accessed through normal operation, a forced segment file 3210 (see FIG. 32) may be defined to force access to these code segments. Forced segment file 3210 contains the code segment numbers of code segments to be forced and has a file name of the format “sourceFileName.FRC”. Within forced segment file 3210, code segments to be forced are listed (e.g., as list of segment numbers separated by white space). For example, if segment 3 and segment 5 and segment 7 are to have forced entry then forced segment file 3210 contains: “3 5 7”.

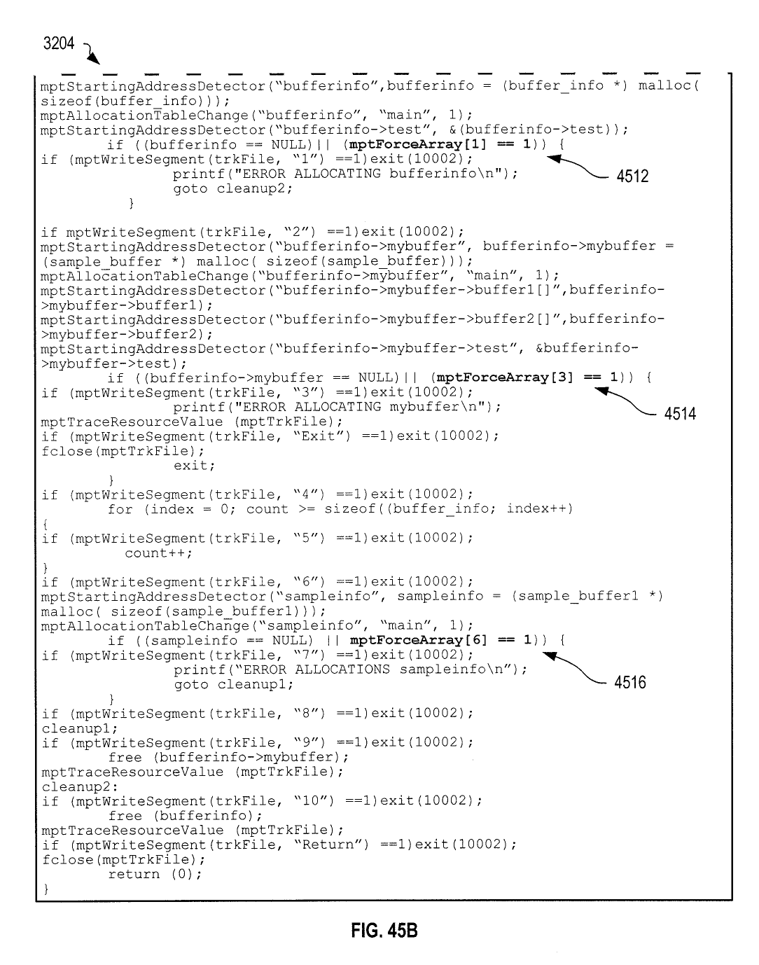

FIGS. 45A and 45B shows augmented source code 3204 with conditional branch forcing. In particular, augmented source code 3204 is modified to include a file handle to forced segment file 3210 at positions 4502 and 4504. A one dimensional force array (e.g., “mptForceArray”) is declared at position 4506 and initialized to zero at position 4508. The force array is declared with the same number of elements as there are code segments within software source code 3202. At position 4510 within augmented source code 3204, forced segment file 3210 is read and elements of the force array corresponding to segments numbers loaded from forced segment file 3210 are set to one. Forced segment file 3210 is then closed.

Within augmented source code 3204, each branch point 4512, 4514, and 4516, is modified to evaluate the appropriate element of the force array. For example, the conditional statement at the entry point of segment six evaluated element six of the force array. Thus, by including the segment number within forced segment file 3210, the force array element associated with that code segment is set to one when the file is read in at run time, and that code segment is entered when the condition for the branch statement is evaluated.

Within augmented source code 3204, for the C language, an additional case is added to case statements (e.g., switch) prior to the default case label, which allows activation of the default via the force file. Further, where the code segment to be forced is embedded within another code segment (e.g., nested, if statements), then all activation of all nesting branch points is required to insure that the targeted code segment is actually activated.

Use of Multiple Program Runs to Access All Segments

Augmented source code 3204 is compiled and then run to produce tracking file 3208 which contains variable address accesses, code segment accesses and times/dates. MBD 111 then processes tracking file 3208 to determine whether all segments within software source code 3202 have been accessed. If all code segments within software source code 3202 have not been accessed, MBD 111 generates a missing segment file 3212 which contains a list of un-accessed code segments. The file name format for missing segment file 3212 is “sourceFileName.MIS.”

The user may view missing segment file 3212 to determine whether additional runs are necessary with modified forced segment file 3210 to activate the identified missed code segments. Tracking file 3208 is cumulative in that output from additional runs of augmented source code 3204 is appended to the file. Missing segment file 3212 regenerated by each run of augmented source code 3204 so that the user knows which segments require profiling. When all code segments of software source code 3202 have been accessed then missing segment file 3212 is not created, thereby indicating that all segments have been analyzed. If a new software source file is provided by the user, then any tracking file with the same source file name is erased from the system, thereby requiring all segments to require analysis.

Interactive Kernel Tracing

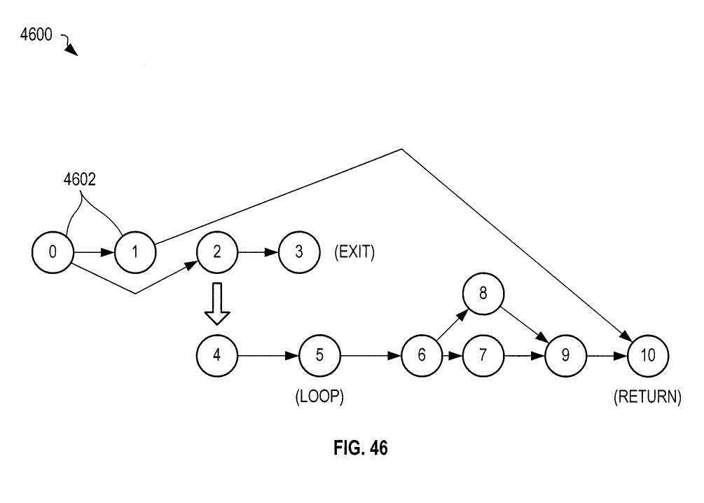

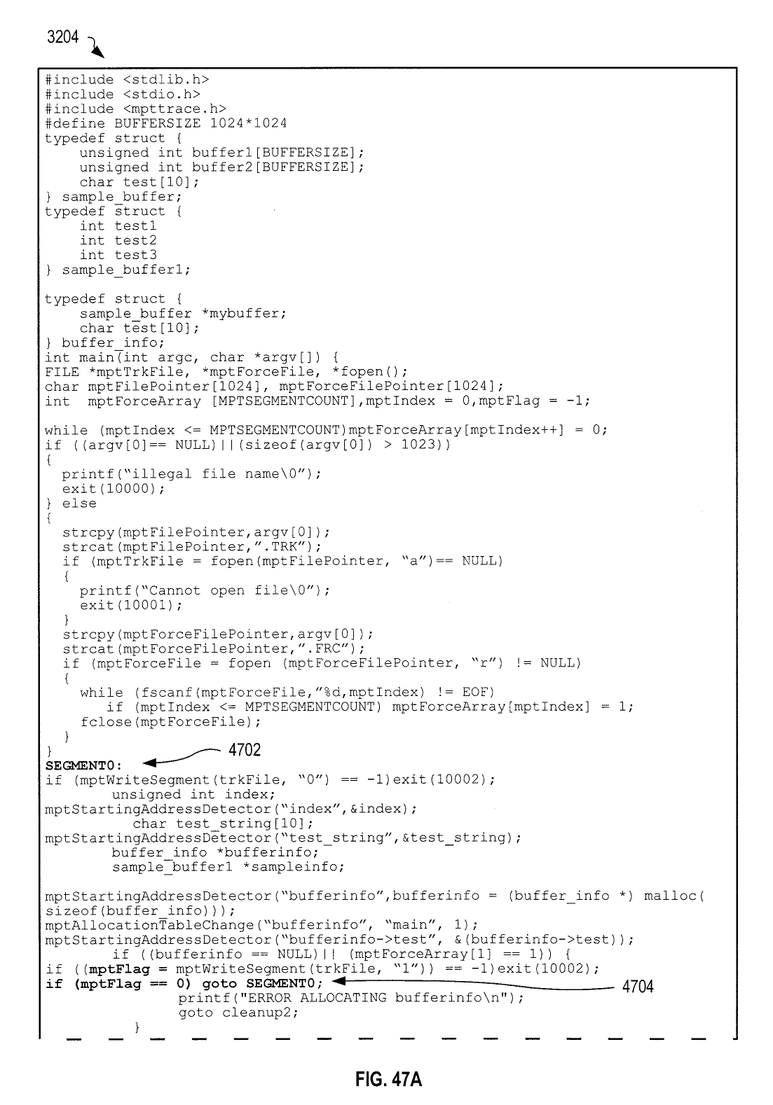

Since testing software source code 3202 may require several runs of augmented source code 3204, MBD 111 allows a user (e.g., developer 152) to interact with user interface 160 within client 156 to trace execution of a submitted kernel interactively. MBD 111 creates a visual representation of a submitted (or selected) kernel (e.g., kernel 204(1), FIG. 2, and software source code 3202, FIG. 32) and displays a function-structure diagram on user interface 160. FIG. 46 shows one exemplary function-structure diagram 4600 illustrating eleven code segments, each represented with their associated segment number as also shown within the mapped source code file (e.g., mapped source code 3206, FIG. 32).

By selecting the “trace” option within user interface 160, a runtime “interactive flag” is set, that causes the write segment function (e.g., “mptWriteSegment ( )”) to stop execution of the kernel at each code segment and allows the user to set the force array (e.g., “mptForceArray[ ]”) interactively prior to continuing execution of the kernel.

In one example of operation, as augmented source code 3204 is executed, the code segment being executed is highlighted within function-structure diagram 4600. MBD 111 stops execution of augmented source code 3204 at each branch point (e.g., branch points 4512, 4514, and 4516 of FIG. 45) and allows the user to select the execution path by clicking the left mouse button on the appropriate arrow emanating from the current code segment of the function-structure diagram 4600. When a path (e.g., arrow) is selected by the user, the selected arrow's color changes, indicating which path is to be taken when the user selects the “Continue” button. Upon selection of the “Continue” button, execution continues based upon the selected path.

The user may select a code segment using a right mouse button to indicate that execution should not halt at that segment. Whenever execution of augmented source code 3204 is halted (e.g., at one of a branch point, an exit, and a return) then the user may optionally display variable names, their starting, ending, and current addresses, as well as their current location values within a pop-up window. For example, the user may click a “View-Change Variables” button within user interface 160 to display these variables. Selecting the current value field of any variable within the pop-up window allows the user to change the variable's data. If the variable is an array then the array index value may also be changed by the user to display that array element's value. Where the user changes a variable's value, code segments executed after the change are not tracked as accessed segment paths. In one embodiment, an array (e.g., “mptVariableArray[ ]” is used to store this variable information for display within the pop-up window.

Furthernore, whenever execution of augmented source code 3204 is halted (e.g., at one of a branch point, an exit, and a return), then the user may optionally display the contents of the mapping file (e.g., mapped source code 3206) within a pop-up window by selecting a “View Code” button within user interface 160. Within this pop-up window, the current code segment is highlighted, for example as determined from execution of the “mptWriteSegment( )” function added to augmented source code 3204. Further again, MBD 111 records the code segments executed within augmented source code 3204 and displays older code segment executions in one or more different colors. Since code segment execution is based upon data within the missing segment file 3212, all segment activation history is reset when a new version of the software source code 3202 is loaded into environment 100.

Code Segment Rollback

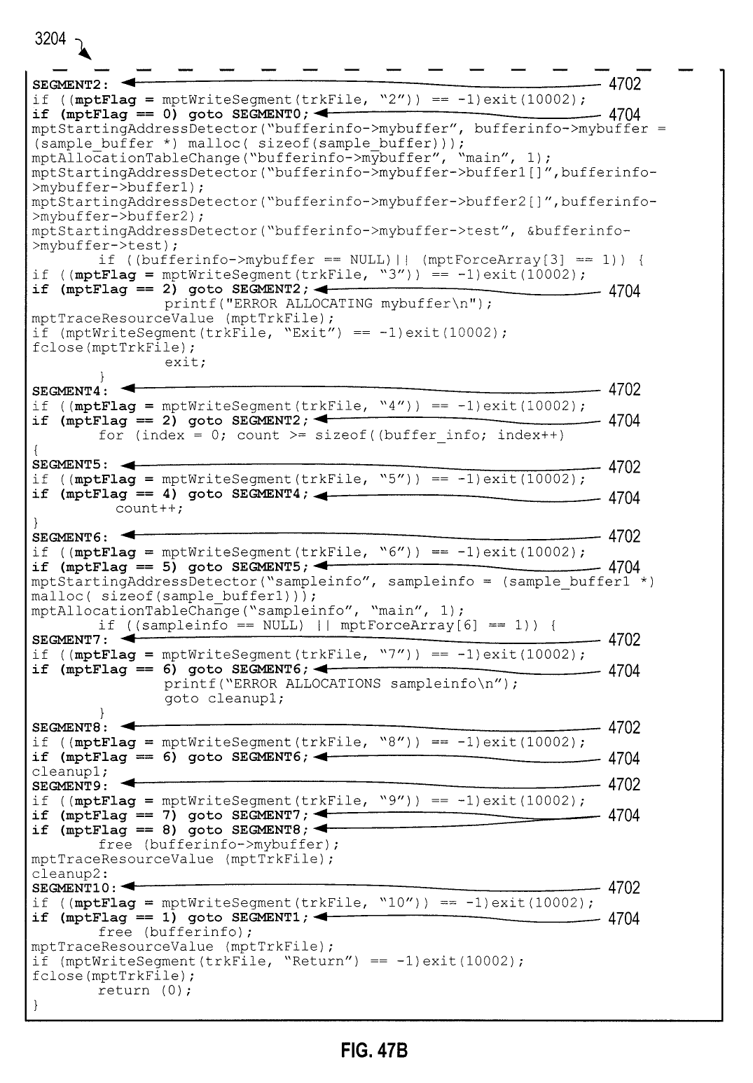

Whenever execution of augmented source code 3204 is halted (e.g., at one of a branch point, an exit, and a return), the user may optionally select a rollback button (e.g., “Rollback Code” button) within user interface 160 to resume execution at the last executed code segment. This is implemented, in one embodiment, by utilizing the last executed code segment returned by the “mptWriteSegment” function, thereby allowing MBD 111 to use that information to transfer control to the returned code segment. FIGS. 47A and 47B show exemplary amendments to augmented source code 3204 to include code tags 4702 (e.g., segment labels) and code to evaluate the returned previously executed segment number (stored within a variable “mptFlag”) from function “mptWriteSegment( )” and conditionally thereupon execute a “goto” command.

Collaborative Kernel Level Debugging

Since the above described functionality and tools are implemented within development server 108, for example, and not on the user's equipment, the interactive activity may also be shared with other developers. For example, multiple users within an organization may each activate trace mode for the same kernel and then simultaneously access the above described tools. In one embodiment, the first person initiating trace of the kernel becomes the moderator and may selectively allow other users access to view and optionally control the interactive session.

In one embodiment, the name of each collaborative user is displayed within user interface 160 and indicated, through highlighting and/or color, which user has control of the currently executed segment. For example, the user with current control may select the name of another user to pass control of the interactive session thereto. Only the user with segment control may select the segment, display code, display variables and/or change variables. Only the moderator may select the “Continue” and the “Rollback Code” buttons. The moderator may change the segment control user at any time during halted execution.

Collaborative Algorithm Tracing

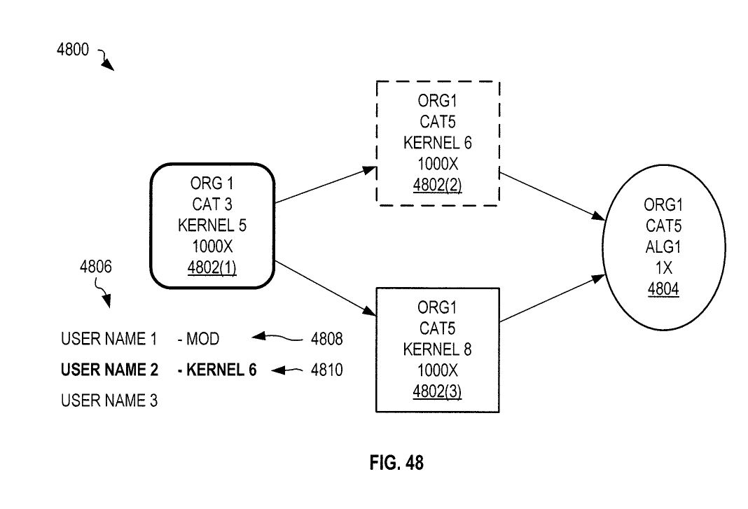

An algorithm may consist of multiple kernels and may include other algorithms. Within user interface 160, the user (e.g., developer 152 or administrator 158) may select an algorithm for tracing by MBD 111. FIG. 48 shows one exemplary algorithm trace display 4800 that shows kernels 4802(1)-(3) and an algorithm 4804. Once the organization/category/algorithm/trace buttons are selected (provided the algorithm was created by the current organization), the MPT Trace screen for algorithms is displayed. Within display 4800, the user may select (e.g., click on with the mouse) any of the kernels or algorithm. In one embodiment, access to kernels and algorithms is limited to those created by the organization of the user.

For example, selecting a kernel results in function-structure diagram 4600, FIG. 46, being displayed for that kernel. The first administrator-level user (e.g., administrator 158) to access the algorithm in trace mode becomes the moderator of that algorithm as indicated 4808 within user list 4806. The current moderator may relinquish the moderator position, for example by selecting a “Release” button within user interface 160. The moderator may assign other users to kernels within the algorithm being traced; user name 2 is shown 4810 moderating kernel 6 4802(2). In one embodiment, assignment occurs when the moderator selects a user name from list 4806 and then selects the kernel to be assigned to that user, whereupon the selected kernel name is displayed 4810 by the user's name. If a kernel 4802 is double clicked by a user, the selected kernel is displayed within a pop-up Kernel Trace window. If another algorithm (e.g., algorithm 4804) within the current algorithm is selected (and is owned by the user's organization), then that algorithm's kernels/algorithms are displayed. The moderator of the top-most algorithm is the moderator for all algorithms.

In one embodiment, the user assigned to each kernel 4802 becomes the moderator of that kernel and proceeds to trace that kernel within MBD 111, as described above (see FIG. 46 and associated description). When all segments for a kernel have been properly accessed and that kernel is considered safe, without errors, and with the required correct answer obtained, then the symbol representing the kernel indicates that the kernel is approved (e.g., shown in bold as within FIG. 48, or is displayed in green). During trace of a kernel by a user, that kernel is displayed in dashed outline (see kernel 4802(2)). All moderator-created assignments remain in force until changed by the moderator.

The moderator is able to assign output values to each kernel/algorithm they are tracing. This is accomplished by double right clicking (selects) on the required kernel or algorithm. The moderator selection of a kernel/algorithm causes the input/output selection popup menu to be displayed. After the “Input” button is selected on the Input/Output selection popup menu then the file or variables selection popup menu is displayed. If the URL of the variable file is entered followed by the selection of the “Continue” button then a file with the following format is used to define all input variables.
(variable name 1, input value 1), . . . (variable name n, input value n);

Blank spaces and line feeds/carriage return characters are ignored. If the variable is an array then the array element that is affected is selected. For example: (test[3], 10) means that the forth element of the array named test will receive the value ten. Any undefined elements are designated “N/A.” Any variable with an “N/A” designation will not be defined.

The selection of the “Display Variables” button within user interface 160 causes all variables for the current kernel/algorithm to be displayed. The moderator may then place values in the current value field of the each variable or enter “N/A,” where “N/A” means that this value is not important. Each element in an array must be defined separately. Any variable that is not given a value is assumed be defined as “N/A.”

The selection of an “Output” button within the “Input/Output” popup menu will cause the “Output File or Variable” popup menu to be displayed. The “Output” files and variables are filled in a manner analogous to the “Input” files or variables.

After all input and output variables are defined then the moderator may select the starting kernel/algorithm for activation. In one embodiment, the moderator left clicks the starting kernel/algorithm followed by left clicking the “Start” button within user interface 160. The algorithm is then processed by development server 108 and once complete the output data is compared to the entered output variable values. The moderated algorithm is considered traced when all algorithm paths possible been selected and when required values have be obtained for each path. An algorithm may be traced when only when all kernels and algorithms defined within that algorithm are successfully traces and considered safe.

Unsafe Code Determination

MBD 111 analyzes tracking file 3208 and missing segment file 3212 to determine whether the tested software source code 3202 is considered safe. If missing segment file 3212 identifies any code segment as untested, the software source code is not considered safe. If, within tracking file 3208, a current address of any variable is outside of that variable's assigned address range during a program run, then the software source code 3202 is not considered safe. If, within tracking file 3208, a code segment is indicated as having a total execution time greater than a defined maximum time is not considered safe.

If, within tracking file 3208, the sum of all execution time of a looping segment (without exiting the looping segment) is greater than a defined maximum time, then the software source code is not considered safe. If, within tracking file 3208, the total execution time for software source code 3202 exceeds a defined maximum time, then the software code is not considered safe. If, within tracking file 3208, there are any allocated variables that never have memory allocated to them, then software source code 3202 is not considered safe. If, within tracking file 3208, more than one memory allocation is made per variable per function, then software source code 3202 is not considered safe.

Ancillary Services

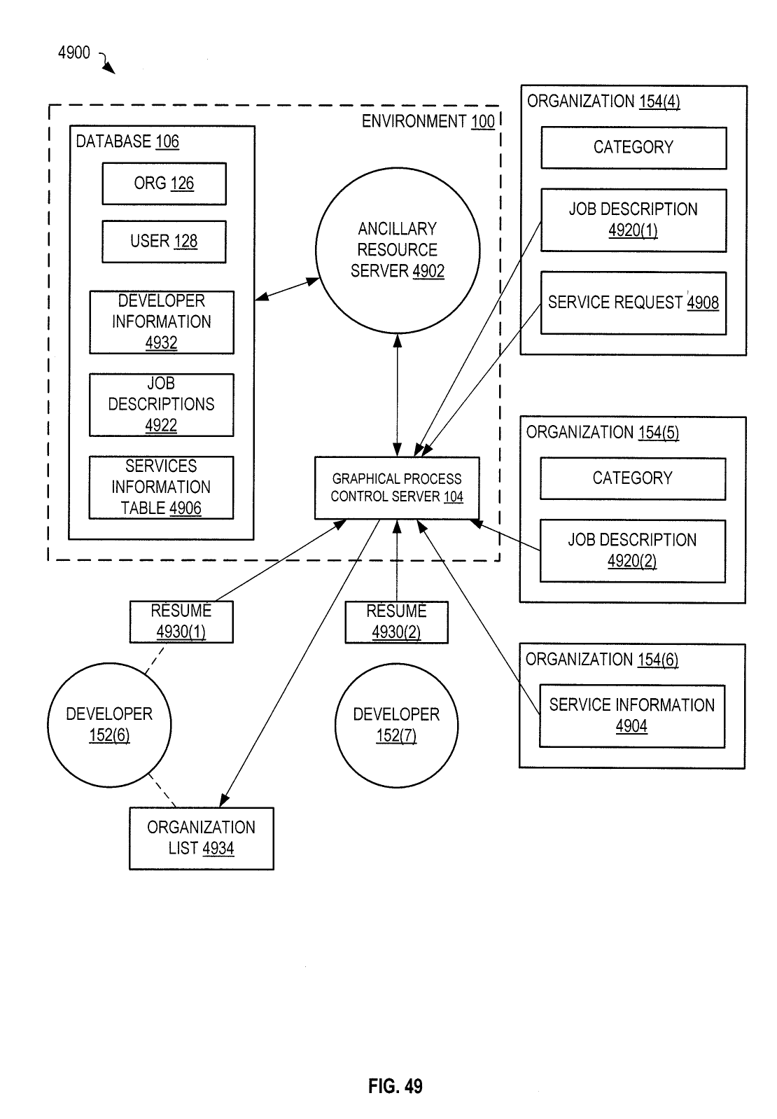

FIG. 49 shows environment 100 of FIG. 1 with an optional ancillary resource server 4902 that provides ancillary services to developers 152, administrators 158, and organizations 154 that utilize environment 100. Ancillary services may include: legal services, technical writing services, language translation services, accounting services, graphic art services, testing/debugging services, marketing services, user training services, etc. Ancillary resource server 4902 may also provide a recruiting service between developers 152 and organizations 154 that utilize development environment 100. Ancillary resource server 4902 may cooperate with one or more of program management server 110, financial server 102, development server 108, cluster 112, and database 106, and may be implemented within an existing server or may utilize one or more other computer servers. Environment 100, through inclusion of ancillary resource server 4902, may thereby offer social networking facilities to organizations 154, administrators 158, and developers 152.

In the example of FIG. 49, ancillary resource server 4902 cooperates with database 106 and graphical process control server 104 to receive service information 4904 from organization 154(6) (or more specifically, an administrator 158 of organization 154(6)). Ancillary resource server 4902 stores service information 4904 within a services information table 4906 of database 106 in association with an entry of organization 126 for organization 154(6). Service information 4904 may include keywords that categorize the service provided by organization 154(6). Continuing with the example, another organization 154(4) may submit, via graphical process control server 104, a service request 4908 to instruct ancillary resource server 4902 to search for services provided by other organizations. Service request 4908 may specify one or more keywords and/or one or more categories associated with the service required by organization 154(4).

Ancillary resource server 4902 retrieves service information and associated organization information from database 106 based upon service request 4908, and presents a list of organizations offering the requested services to organization 154(4). In one embodiment, service information 4904 may be presented as a graphic similar to a kernel (e.g., kernels 204, FIG. 2). Continuing with the example of FIG. 49, where service request 4908 matches keywords or other service information 4904 of organization 154(6), ancillary resource server 4902 includes information of organization 154(6) within a list of organizations offering matching services. Organization 154(4) (more specifically an administrator 158 of organization 154(4)) may then select one or more organizations from that list from which estimates for the required service are solicited. Ancillary resource server 4902 then presents, via graphical process control server 104, and/or sends the service request information to the selected organizations (organization 154(6) in this example). The selected organizations may evaluate the service requests and decline or accept to respond.

In another example of FIG. 49, organizations 154(4) and 154(5) send job descriptions 4920(1) and 4920(2), respectively, to ancillary resource server 4902 via graphical process control server 104. Job descriptions 4920 include work requirements and/or positions within the submitting organization 154. Ancillary resource server 4902 stores job descriptions 4920 within a job descriptions table 4922 of database 106.

Developers (e.g., developers 152(6) and 152(7)) that are interested in finding work in association with environment 100 may submit résumés (e.g., résumés 4930(1) and 4930(2), respectively) to ancillary resource server 4902 via graphical process control server 104. Ancillary resource server 4902 stores résumés 4930(1) and 4930(2) within developer information table 4932 of database 106. Each developer 152 may then interact with ancillary resource server 4902, via graphical process control server 104, to search for jobs within job descriptions 4922 based upon an input category and/or one or more keywords. In response, ancillary resource server 4902, via graphical process control server 104, may display a list 4934 of organizations (e.g., organizations 154(4) and 154(5)) offering work to the developer. Selection, by the developer (e.g., developer 152(6)) of one or more of these organizations on list 4934 is received by ancillary resource server 4902 and stored within database 106 in association with developer 152(6) and job descriptions 4922.

Administrators 158 of organizations 154(4) and 154(5) may each interact with ancillary resource server 4902, via graphical process control server 104, to evaluate résumés 4930 of developers 152 that have selected their organization from organization list 4934. In the example of FIG. 49, where developer 152(6) selects organization 154(4) from organization list 4934, organization 154(4) may receive notification of interest in job description 4920(1) from ancillary resource server 4902. Organization 154(4) may interact with ancillary resource server 4902, via graphical process control server 104, to view a list of developers 152 that have responded to job description 502(1). Résumé information (e.g., résumé 4930(1)) of each listed developer may be viewed, and zero, one or more developers may be selected by the administrator of the organization, whereupon the associated developer information is associated with that organization within database 106. For example, upon acceptance by an administrator 158 of organization 154(4), information of developer 152(6) is associated with organization 154(4), and the developer becomes a member of that organization.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A parallel processing computing development environment comprising:
a graphical process control server providing an interface through which at least one developer may access the development environment to create a parallel processing routine including at least one of (a) a kernel and (b) an algorithm; and
a financial server for managing license and usage fees for the parallel processing routine, wherein the developer of the parallel processing routine receives a portion of the license and usage fees.

2. The environment of claim 1, wherein the financial server receives input from at least one administrator to determine, for the parallel processing routine, at least one of (a) a licensing cost, (b) a usage cost, and (c) a publish authority, wherein the publish authority indicates whether the routines may be shared with other organizations.

3. The development environment of claim 1, wherein:
a first developer accesses the development environment to create a first kernel, and a second developer accesses the development environment to create a first algorithm that uses the first kernel; and
the financial server is used for licensing the first kernel to the second developer for a license fee and for paying the first developer at least part of the license fee.

4. The environment of claim 3, wherein the financial server retains a portion of the license fee as payment for utilization of the environment by the first developer.

5. The environment of claim 3, including a development server that profiles a second kernel and compares profile results for the second kernel against the profile results for the first kernel to determine the relative performance of the kernels.

6. A parallel processing development environment, comprising:
a database for storing information concerning at least one developer and a plurality of organizations;
a graphical process control server for providing an interface to interact with the developer and the organizations; and
an ancillary resource server that cooperates with the graphical process control server to (a) receive, from the developer, a résumé of the developer, and (b) receive, from at least one of the organizations, a description of a job to be performed;
wherein the ancillary resource server is capable of interactively providing a list of organizations that offer work matching the résumé of the at least one said developer, receiving a selection of the at least one organization by the developer, and transmitting the résumé of the developer to the selected organization; and wherein one of the organizations responds to the developer with information relating to the work to be performed based on information in the résumé.

7. A computer-implemented method, operative within a parallel processing development environment, for automatically determining profile data for a parallel processing routine executing on a parallel processing system including a cluster of processing nodes comprising:
executing the parallel processing routine to process test data on a single processing node of the cluster to determine a first execution time;
calculating, within a development server, a projected execution time for executing the parallel processing routine to process the test data concurrently on N processing nodes of the cluster by dividing the first execution time by N;
executing the parallel processing routine to process the test data concurrently on N processing nodes of the cluster to determine a second execution time; and
calculating, within the development server, an Amdahl Scaling of the parallel processing routine by dividing the projected execution time by the second execution time;
wherein the Amdahl Scaling and the first execution time form at least part of the profile data.

8. The method of claim 7, further comprising determining, within the development server, a maximum amount of RAM used by the parallel processing routine, wherein the profile data includes the maximum amount of RAM used.

9. The method of claim 7, further comprising:
selecting at least one similar parallel processing routine in the parallel processing environment based upon:
at least one of (a) a defined category and (b) defined keywords for each of the parallel processing routines, and
keywords associated with each of the parallel processing routines;
performing the steps of executing and calculating for each of the selected similar parallel processing routines to determine reference profiles; and
comparing the profile data to each of the reference profiles to evaluate and rank the parallel processing routine against selected parallel processing routines.

10. A computer-implemented method for identifying plagiarism in source code of parallel processing routines comprising:
(a) removing formatting, comments, variable names, and file names from a candidate source code file to create a first source compare file;
(b) identifying similar existing parallel processing routines within a database based upon a selected category and keywords in the candidate source code file;
(c) selecting a next source code file of the identified parallel processing routines;
(d) removing formatting, comments, variable names, and file names from the selected source code file to form a second source compare file;
(e) comparing the first source compare file to the second source compare file to determine a percentage of code statements in the first source compare file that match code statements in the second source compare file;
(f) rejecting the candidate source code file if the determined percentage is greater than a predefined value; and
(g) repeating steps (c) through (f) to compare the candidate source code file to the selected source code file until file comparison is terminated or until the candidate source code file is rejected; and
(h) determining that the candidate source code file has plagiarized the selected source code file if the determined percentage is greater than the predefined value.

11. The method of claim 10, wherein multiple instances of the source code for each said source code file are created to generate respective ones of the source compare files;
wherein each of the instances represents one permutation of independent statements within their respective code blocks; and
wherein each said permutation is created by placing, within a particular code block, source code statements that are determined as independent, along with any associated statements, provided the placement does not affect the dependency of any statements within the block.

12. The method of claim 11, wherein:
each said permutation is created by grouping the software code statements in each of the source code files into blocks including two or more code statements without a looping or branching statement separating them; and
the source code statements that are determined as independent do not include variables found in the right side of an assignment statement within a code block is also found on the left side of any preceding assignment statement within that same block.

13. A computer-implemented method for identifying plagiarism in source code for a parallel processing system comprising:
redacting non-instructional characters, comments, variable names, and file names from a plurality of source code files to create a plurality of redacted source code files;
comparing a first one of the redacted source code files to each of a plurality of the remaining redacted source code files to determine a percentage of code statements in the first one of the redacted source code files that match code statements in the plurality of the remaining redacted source code files; and
determining that the first one of the redacted source code files has plagiarized one of the remaining redacted source code files if the determined percentage is greater than a predefined value.

14. The method of claim 13, wherein multiple instances of the source code for each of the source code files are created to generate respective ones of the source compare files; wherein each of the instances represents one permutation of independent statements within their respective code blocks.

15. The method of claim 13, wherein each said permutation is created by grouping the software code statements in each of the source code files into blocks including two or more code statements without a looping or branching statement separating them.

16. A computer-implemented method for identifying plagiarism in source code of a parallel processing function comprising:
redacting non-instructional characters, comments, variable names, and file names from a candidate function in a source code file containing to create a first component redaction compare file;
identifying similar functions within a database based upon matches between the similar functions and a selected category and keywords in a source code file containing the candidate function;
selecting a next function in the identified similar functions;
redacting non-instructional characters, comments, variable names, and file names from the selected next function to form a second component redaction compare file;
comparing the component redaction compare file to the second component redaction compare file to determine a percentage of code statements in the first component redaction compare file that match code statements in the second component redaction compare file; and
determining that the candidate function in the source code file has plagiarized the selected next function if the determined percentage is greater than a predefined value.

17. A system for facilitating development of a parallel processing routine, comprising:
a graphical process control server including an interface through which at least one developer server may access a development environment of the system to create the parallel processing routine;
a development server for receiving the parallel processing routine from the graphical process control server and storing the parallel processing routines within a database;
a financial server for accruing, for the parallel processing routine, one or both of (a) a license fee and (b) a usage fee, the financial server capable of distributing at least part of the accrued license fee and at least part of the accrued usage fee to an owner of the system, the financial server further capable of distributing at least part of the accrued license fee and the accrued usage fee to a developer of the parallel processing routine.

18. A method for tracking financial reward for a developer of a parallel processing routine, comprising the steps of:
accruing, within a financial server of a development environment of the parallel processing routine, a license fee associated with the parallel processing routine;
accruing, within the financial server, a usage fee associated with a use of the parallel processing routine; and
distributing at least part of the accrued license fee and at least part of the accrued usage fee to a developer of the parallel processing routine.
